(19) United States
(12) Patent Application Publication
(10) Pub. No.: US 2009/0083440 A1
(43) Pub. Date: Mar. 26, 2009

(54) DOCUMENT MANAGEMENT SERVER AND CONTROL METHOD OF DOCUMENT MANAGEMENT SERVER

(75) Inventor: Shuuhei Kawakami, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/212,521

(22) Filed: Sep. 17, 2008

(30) Foreign Application Priority Data
Sep. 21, 2007 (JP) 2007-245369

(51) Int. Cl. G06F 15/16

(52) U.S. Cl. 709/245

(57) ABSTRACT

A document management server includes: a storage unit configured to store a document as associated with a temporarily registered user ID; a determining unit configured to determine whether to perform main registration of the temporarily registered user ID or to reject main registration; and a transmitting unit configured to transmit information for the purpose of obtaining the document to a transmission destination associated with the temporarily registered user ID, in the case of determining with the determining unit to reject the main registration. Thus, an unregistered user can temporarily register a document.

### BACKGROUND OF THE INVENTION

1. Field of the Invention

The present invention relates to a document management server and control method of a document management server.

2. Description of the Related Art

Heretofore, there has been a document management system which can transmit a document scanned from an image forming device having functions such as scanning, printing, copying, and so forth as to a document management server configured on the Internet, and which can register the transmitted document.

Normally, with such a document management system, a user first inputs a user ID registered in an image forming device (hereafter, device user ID) in the image forming device and logs in. Thereafter, the user inputs the user ID registered beforehand in a document management server (hereafter, document management server user ID) in the image forming device. Further, upon the user setting an original document as to the image forming device and inputting document scan instructions in the image forming device, the image forming device scans the original document and creates a document. Generally, upon transmitting a created document and a document management server user ID input by the user from the image forming device as to the document management server, the document received by the document management server is associated with the received document management server user ID and registered.

That is to say, in such a case, a device user ID is registered as to a user, but the document management server user ID is not registered. In this case, with a generally-used document management system, the user submits registration of the document management server user ID to the manager of the document management server (hereafter, manager) beforehand. Subsequently, the client PC transmits registration instructions from the manager for the user ID input to the document management server. The user ID is registered according to the registration instructions of the user ID received by the document management server. Upon such process being executed, the user can then input the registered document management server user ID as to the image forming device. Thus, the image forming device transmits the input document management server user ID and document to the document management server, enabling the document management server to register the received document.

On the other hand, there has been an electronic depot system wherein a general user transmits a document from a user terminal device to an electronic depot and temporarily registers the document therein, and an authorizing user performing authorization of the temporarily registered document, whereby the temporarily registered document is registered in the electronic depot. (See Japanese Patent Laid-Open No. 2002-288183.)

Now, let us assume a combination of two technologies of a document management system used up to now, and an electronic depot system disclosed in Japanese Patent Laid-Open No. 2002-288183. First, a user not having a user ID for a document management server inputs an original document to be scanned in the image forming device, whereby after scanning the original document and creating a document, the image forming device transmits the created document to the document management server. Subsequently, the document management server temporarily registers the user in the event of receiving the document, and further, associates the document with the temporarily registered user, and temporarily registers the received document. Upon the manager permitting main registration of a user ID temporarily registered as to a client PC, the client PC transmits the main registration of the user ID temporarily registered on the document management server. Upon receiving the main registration of the temporary registration user, the document management server main-registers the temporary registration user, and can main-register the temporary registration document which is associated to the temporary registration user and main-registered.

However, with such a document management system, in order for a user not having a document management server user ID to have the user ID of oneself main-registered by the manager, the user would request registration outside of the document management system, such as emailing or telephoning the manager. Further, in order to heighten security of user ID main registration processing, in the event that the manager accepts main registration of the document management server user ID outside the system, the manager would perform identity confirmation of the user requesting the user ID main registration, such as requesting display of personal identification of the user. However, with the method herein, an authentication process such as referencing the personal identification is performed outside of the document management system, and this has caused additional work for the user requesting the user ID main registration and for the manager.

On the other hand, with such a document management system, in the event of the image forming device transmitting a document to the document management server and temporarily registering the document, the user would input the document in a folder on the document management server to main-register the document as to the image forming device. Therefore, before inputting the temporary registration of the document in the image forming device, the user would obtain a user ID by asking a user holding a user ID already main-registered. Also, in such a case, in the case that the user ID main registration is rejected by the manager, regardless of the user ID not being main-registered in the document management server, the user can know that the obtained folder exists, thereby causing security problems.

Thus, with such a document management system, in the case that the manger rejects the main registration of the user ID temporarily registered in the document management server, the document which is associated with the temporary registration user ID and temporarily registered generally has been completely deleted. However, with the above-described document management system, in the case that the manger rejects the main registration of the temporary registration user ID, if the document associated with the temporary registration user ID and temporarily registered is completely deleted, the document transmitted by the user from the image forming device to the document management server is lost. Thus, in the case that the original document wherein the document is scanned is already lost, there is the problem of difficulty in scanning and creating the document again. Also, the work of the user temporarily registering the document on the document management server is wasted.

### SUMMARY OF THE INVENTION

The document management server according to an embodiment of the present invention has a storage unit configured to store a document as associated with a temporarily registered ID; a determining unit configured to determine whether to perform main registration of the temporarily registered ID or to reject the main registration of the temporarily registered ID; and a transmitting unit configured to transmit information for the purpose of obtaining the document to a transmission destination associated with the temporarily registered ID, in the case that the determining unit determines to reject the main registration of the temporarily registered ID.

Further features of the present invention will become apparent from the following description of exemplary embodiments with reference to the attached drawings.

### BRIEF DESCRIPTION OF THE DRAWINGS

FIG. 1 is a block diagram illustrating a document management system according to an embodiment of the present invention.

FIG. 2 is a flowchart describing a sequence to obtain a temporary registration document with a client PC, according to input from a user.

FIG. 3 is a diagram illustrating an example of a temporary registration user rejection notification email displayed on the client PC.

FIG. 4 is a diagram illustrating user information, device information, temporary registration user information, document information, temporary registration document information, device user information, and transmission destination information.

FIG. 5 is a flowchart describing a sequence to perform temporary registration of the user and document in a document management server with an image forming device, according to input from a user.

FIG. 6 is a flowchart describing a sequence to perform temporary registration of the document with the document management server, according to a request from the image forming device.

FIG. 7 is a flowchart describing a sequence to perform main registration or rejection of a temporary registration user with the client PC, according to input from a manager.

FIG. 8 is a flowchart describing a sequence to perform main registration or rejection of a temporary registration user with the document management server, according to a request from the client PC.

FIG. 9 is a flowchart describing a sequence to perform main registration of a document with the client PC, according to input from a user.

FIG. 10 is a flowchart describing a sequence to perform main registration of a document with the document management server, according to a request from the client PC.

FIG. 11 is a flowchart describing a sequence to obtain a temporary registration document with the client PC, according to input from a user.

FIG. 12 is a flowchart describing a sequence to perform transmission of a temporary registration document with the document management server, according to a request from the client PC.

FIG. 13 is a diagram illustrating an example of a device login screen displayed on the image forming device.

FIG. 14 is a diagram illustrating an example of a device processing screen displayed on the image forming device.

FIG. 15 is a diagram illustrating an example of a transmission destination selection screen displayed on the image forming device.

FIG. 16 is a diagram illustrating an example of a transmission result screen displayed on the image forming device.

FIG. 17 is a diagram illustrating an example of a main registration/rejection request email for a temporary user displayed on the client PC.

FIG. 18 is a diagram illustrating an example of a manager login screen displayed on the client PC.

FIG. 19 is a diagram illustrating an example of a manager login error screen displayed on the client PC.

FIG. 20 is a diagram illustrating an example of a main registration screen for a temporary user displayed on the client PC.

FIG. 21 is a diagram illustrating an example of a main registration result screen for a temporary user displayed on the client PC.

FIG. 22 is a diagram illustrating an example of a main registration notification email for a temporary user displayed on the client PC.

FIG. 23 is a diagram illustrating an example of a rejection notification email for a temporary registration user displayed on the client PC.

FIG. 24 is a diagram illustrating an example of a user login screen displayed on the client PC.

FIG. 25 is a diagram illustrating an example of a user login error screen displayed on the client PC.

FIG. 26 is a diagram illustrating an example of a main registration screen for a temporary registration document displayed on the client PC.

FIG. 27 is a diagram illustrating an example of a main registration folder selection screen for a temporary registration document displayed on the client PC.

FIG. 28 is a diagram illustrating an example of a temporary registration user login screen displayed on the client PC.

FIG. 29 is a diagram illustrating an example of a temporary registration user login error screen displayed on the client PC.

FIG. 30 is a diagram illustrating an example of a temporary registration document obtaining screen displayed on the client PC.

FIG. 31 is a flowchart describing a sequence to perform main registration or rejection of a temporary registration user with the document management server, according to a request from the client PC, according to a second embodiment.

### DESCRIPTION OF THE EMBODIMENTS

### First Embodiment

A first embodiment of the present invention will be described with reference to the drawings. Note that in the description below, the term “document” indicates an electronic file including content of an original document, and “document information” indicates information relating to the document.

Note that the Japanese Patent Laid-Open No. 2002-288183 and the first embodiment differ in one point as follows. With the electronic depot system of the Japanese Patent Laid-Open No. 2002-288183, a document can be temporarily registered from a user terminal device only in the case that the user has a user ID in the electronic depot system. However, with the document management server according to the present embodiment also, even if a user does not hold a user ID for the document management server, in the case that the user has a user ID in the image forming device upon authenticating the image forming device, the user ID can be temporarily registered and the document can be temporarily registered.

Also, with the electronic depot system in Japanese Patent Laid-Open No. 2002-288183, diagram data and document data temporarily registered in the electronic depot system can be authorized as authorized diagram data and document data. That is to say, a folder which existed at the point in time that the diagram data and document data are temporarily registered is specified and temporary registration is performed, after which, in the case that authorizing is performed, the diagram data and document data are stored in the folder specified at the time of temporary registration. However, with the document management server according to the present invention, the folder for registering the temporary registration document is specified at the time of temporary registration for document registration. Thus, with the document management system according to the present invention, the document can be temporarily registered, even in a case wherein the folder differs from the time of temporary registration until the time of registration, or even in a case wherein the document cannot be temporarily registered in a folder which did not exist at the time of temporary registration but exists at the time of registration.

Also, with the electronic depot system in Japanese Patent Laid-Open No. 2002-288183, in the case that the diagram data and document data temporarily registered in the electronic depot system is denied, the diagram data and document data is not registered, but rather is deleted. However, with the document management system according to the present invention, an arrangement is made wherein a user can obtain a fixed period temporary registration document for s fixed period in the case that the manger rejects the user registration. Therefore, with the present document management system, even in the case that user registration in the document management server is rejected, a fixed-period document can be obtained, and the waste of work in registering the temporary registration document can be suppressed.

### First Embodiment

### Document Management System

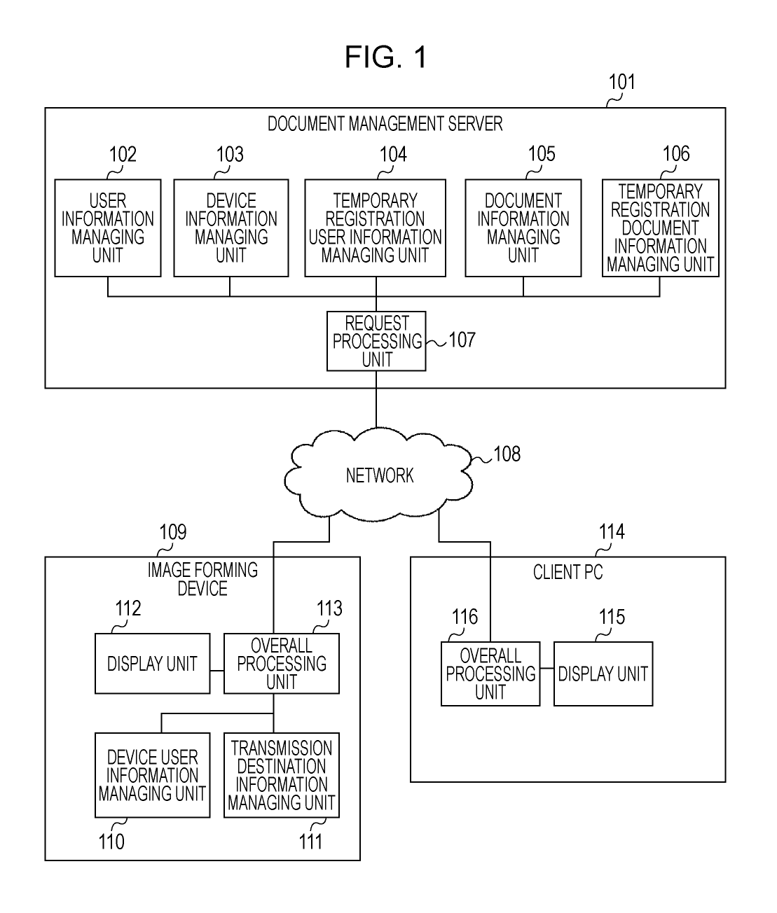

First, the main document management system will be described with reference to FIG. 1. FIG. 1 is a block diagram showing a document management system relating to an embodiment of the present invention. As shown in FIG. 1, the document management system has a document management server 101, and via a network connected thereto has an image forming device 109 and client PC 114. The document management server 101 provides a document main registration function, user temporary registration function, document temporary registration function, main registration and delete function for temporary registration user, and main registration and delete function for temporary registration documents. The image forming device 109 provides a document transmission function. The client PC provides a temporary registration user main registration request function, temporary registration document main registration request function, and temporary registration document obtaining request function.

The document management server 101 has a user information managing unit 102, device information managing unit 103, temporary registration user information managing unit 104, document information managing unit 105, temporary registration document information managing unit 106, and request processing unit 107.

The image forming device 109 has a device user information managing unit 110, transmission destination information managing unit 111, display unit 112, and overall processing unit 113.

The client PC 114 has a display unit 115 and an overall processing unit 116.

### Diagram Illustrating User Information, Device Information, Temporary Registration Information, Document Information, Temporary Registration Document Information, Device User Information, And Transmission Destination Information

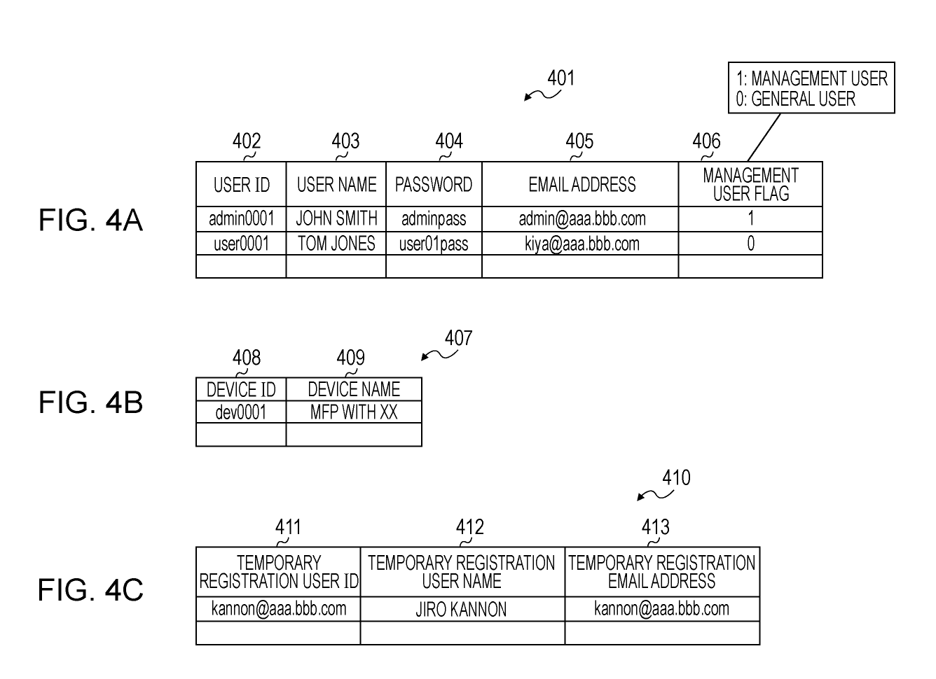

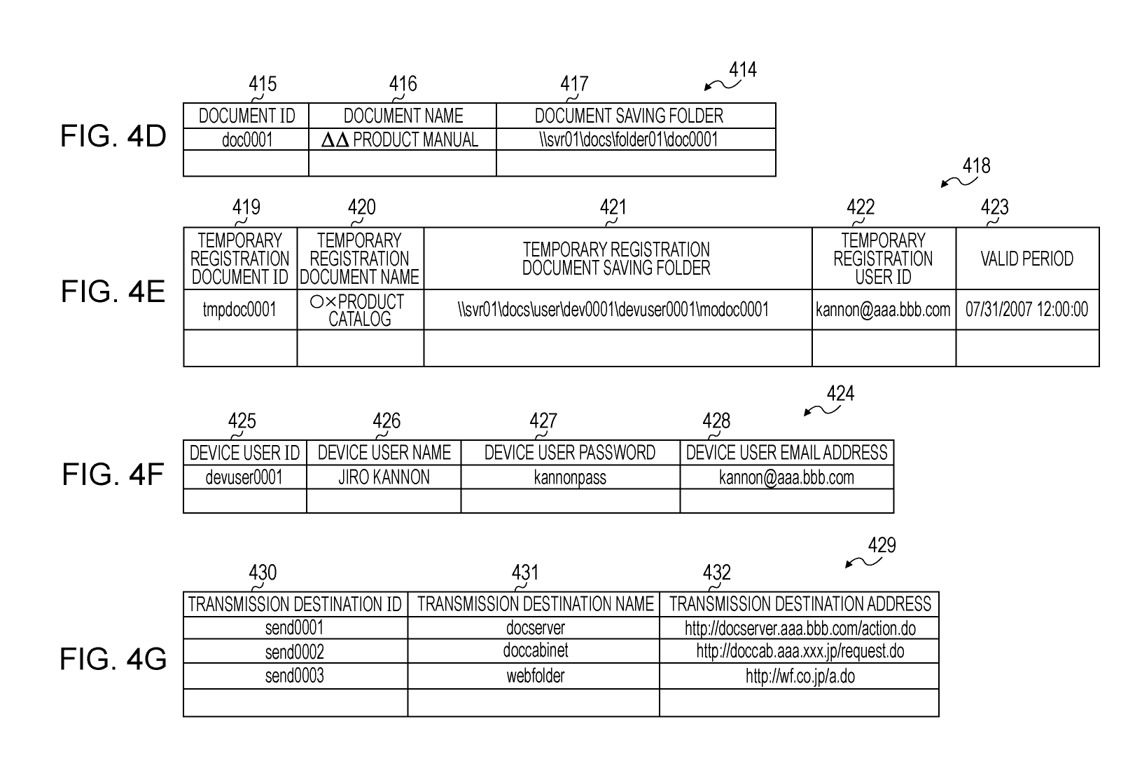

A user information database 401 in FIG. 4A shows user information data configuration. The rows in the database 401 indicate user information. Note that the user information shown in FIG. 4A is user information stored in the user information managing unit 102 of the document management server 101.

The various columns of data in the database 401 each indicate a user ID 402, user name 403, password 404, email address 405, management user flag 406, and so forth. Also, with the data shown in the management user flag 406, “1” indicates that the user thereof is a management user, and “0” indicates that the user thereof is a general user.

With the present embodiment, the data shown in the database 401 is one example, and more databases may be provided. Also, other added information may be stored in the database 401 (information such as user authority, user affiliation, user address, and user contact information). Further, with the present embodiment, each record in the database 401 is stored in the storage device in database format. However, it goes without saying that these records may be stored in the storage device in file format.

A database 407 of the device information in FIG. 4B shows a data configuration for device information. The rows in the database 407 indicate device information. Note that the device information shown in FIG. 4B is device information stored in the device information managing unit 103 of the document management server 101. The data in each column of the database 407 indicates a device ID 408, device name 409, and so forth, respectively.

With the present embodiment, the data shown in the database 407 is one example, and more databases may be provided. Also, other added information may be stored in the database 407 (information such as device type, device installation location, and device function). Further, with the present embodiment, each record in the database 407 is stored in the storage device in database format. However, it goes without saying that these records may be stored in the storage device in file format.

A database 410 of the temporary registration user information in FIG. 4C shows a data configuration for temporary registration user information. The rows in the database 410 indicate temporary registration user information. Note that the temporary registration user information shown in FIG. 4C is temporary registration user information stored in the temporary registration user information managing unit 104 of the document management server 101. The data in each column of the database 410 indicates a temporary registration user ID 411, temporary registration user name 412, temporary registration user email address 413, and so forth.

With the present embodiment, the data shown in the database 410 is one example, and more databases may be provided. Also, other added information may be stored in the database 410 (information such as authority of temporary registration user, affiliation of temporary registration user, address of temporary registration user, contact information of temporary registration user, and so forth). Further, with the present embodiment, each record in the database 410 is stored in the storage device in database format. However, it goes without saying that these records may be stored in the storage device in file format.

A database 414 of the document information in FIG. 4D shows a data configuration for document information. The rows in the database 414 indicate document information. Note that the document information shown in FIG. 4D is document information stored in the document information managing unit 105 of the document management server 101. The data in each column of the database 414 indicates a document ID 415, document name 416, document saving folder 417, and so forth, respectively.

With the present embodiment, the data shown in the database 414 is one example, and more databases may be provided. Also, other added information may be stored in the database 414 (information such as document access authority, document type, document size, number of pages, information of date and time last updated, and so forth). Further, with the present embodiment, each record in the database 414 is stored in the storage device in database format. However, it goes without saying that these records may be stored in the storage device in file format.

A database 418 of the temporary registration document information in FIG. 4E shows a data configuration for temporary registration document information. The rows in the database 418 indicate temporary registration document information. Note that the temporary registration document information shown in FIG. 4E is temporary registration document information stored in a temporary registration document information managing unit 106 of the document management server 101. The data in each column of the database 418 indicates a temporary registration document ID 419, temporary registration document name 420, temporary registration document saving folder 421, temporary registration user ID 422, valid period 423, and so forth.

With the present embodiment, the data shown in the database 418 is one example, and more databases may be provided. Also, other added information may be stored in the database 418 (information such as temporary registration document access authority, temporary registration document type, temporary registration document size, temporary registration number of pages, information of date and time last updated, and so forth). Further, with the present embodiment, each record in the database 418 is stored in the storage device in database format. However, it goes without saying that these records may be stored in the storage device in file format.

A database 424 of device user information in FIG. 4F shows a data configuration for device user information. The rows in the database 424 indicate user information. Note that the user information shown in FIG. 4F is device user information stored in the device user information managing unit 110 of the image forming device 109. The data in each column of the database 424 indicates a device user ID 425, device user name 426, device user password 427, device user email address 428, and so forth, respectively.

With the present embodiment, the data shown in the database 424 is one example, and more databases may be provided. Also, other added information may be stored in the database 424 (information such as device user authority, device user affiliation, device user address, device user contact information, and so forth). Further, with the present embodiment, each record in the database 424 is stored in the storage device in database format. However, it goes without saying that these records may be stored in the storage device in file format.

A database 429 of transmission destination information in FIG. 4G shows a data configuration for transmission destination information. The rows in the database 429 indicate transmission destination information. Note that the transmission destination information shown in FIG. 4G is transmission destination information stored in the transmission destination information managing unit 111 of the image forming device 109. The data in each column of the database 429 indicates a transmission destination ID 430, transmission destination name 431, transmission destination address 432 and so forth.

With the present embodiment, the data shown in the database 429 is one example, and more databases may be provided. Also, other added information may be stored in the database 429 (information such as transmission destination type, protocols, and so forth). Further, with the present embodiment, each record in the database 429 is stored in the storage device in database format. However, it goes without saying that these records may be stored in the storage device in file format.

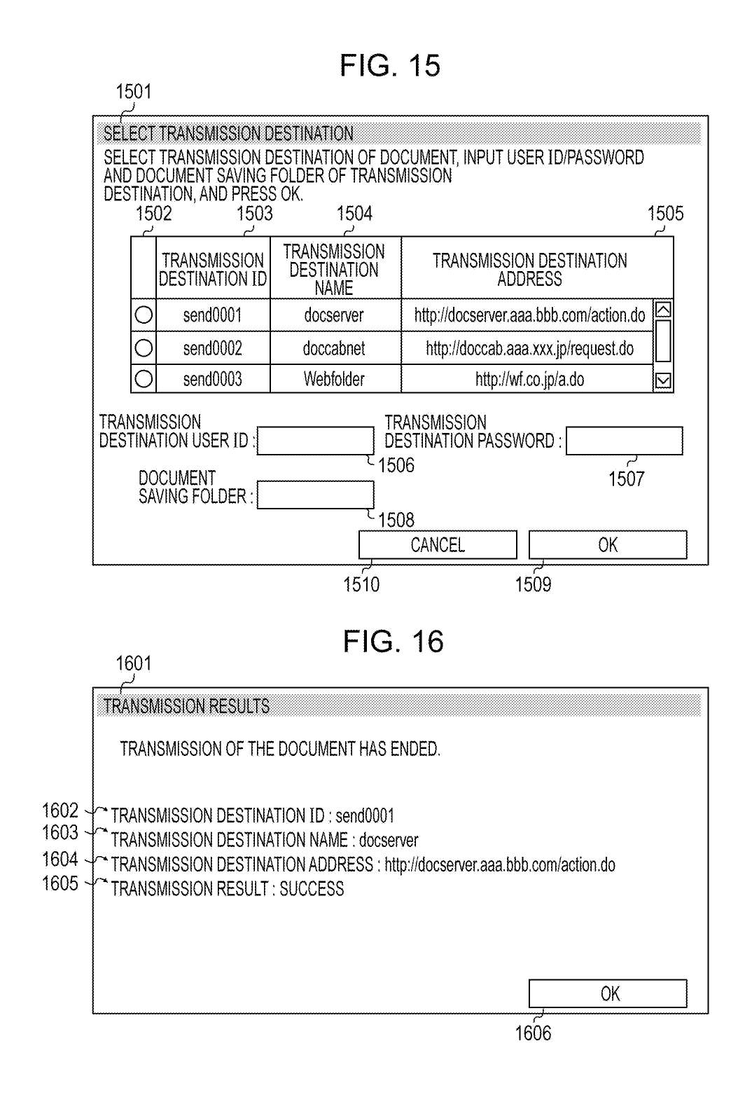

The transmission destination information is information displayed on a transmission destination ID display 1503, transmission destination name display 1504, transmission destination address display 1505 shown in FIG. 15 to be described later. That is to say, data for the transmission destination ID 430 is displayed in the transmission destination ID display 1503 column. Also, data for the transmission destination name 431 is displayed in the transmission destination name display 1504 column. Also, data for the transmission destination address 432 is displayed in the transmission destination address display 1505 column.

### Flowchart of Image Forming Device at Time of Document Temporary Registration

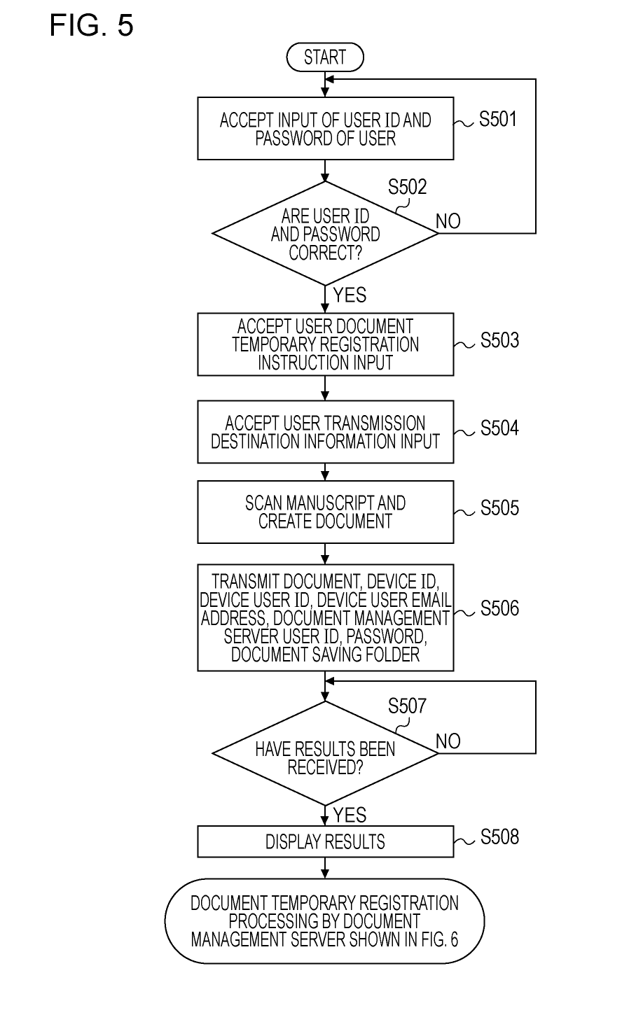

Next, the temporary registration processing of the user and document by the image forming device 109 will be described with reference to FIG. 5. FIG. 5 is a flowchart showing a sequence for temporary registration of the user and document by the image forming device 109.

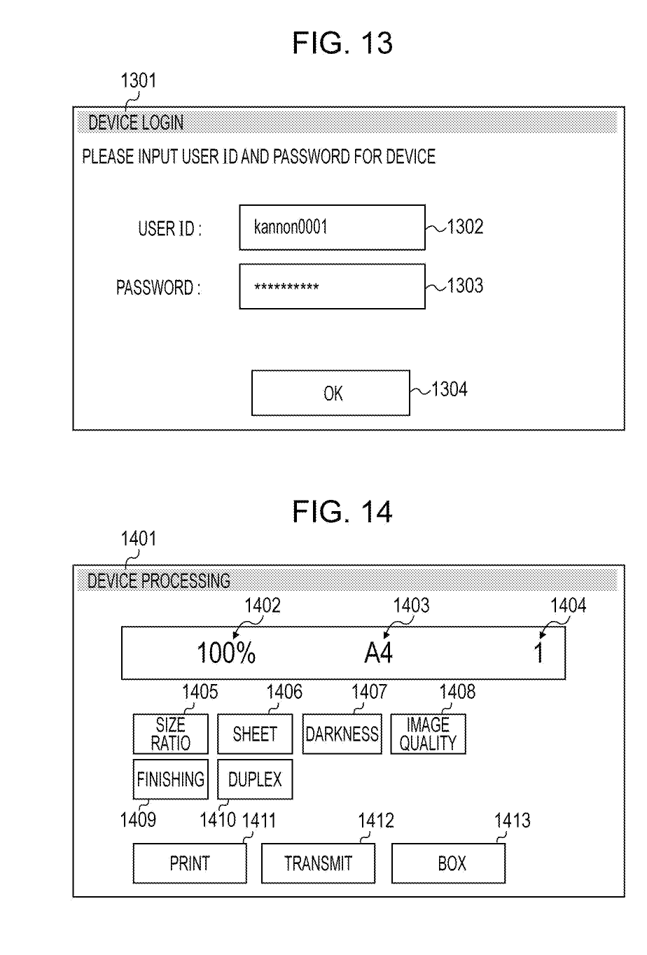

With the image forming device 109, as shown in FIG. 5, first in step S501, an overall processing unit 113 requests the display unit 112 to display a device login screen 1301 shown in FIG. 13 to be described later. The display unit 112 displays the device login screen 1301 shown in FIG. 13 to be described later according to the request thereof. Next, the display unit 112 accepts input of a user ID and password in a user ID input box 1302 and password input box 1303 on the device login screen 1301 shown in FIG. 13 to be described later. The display unit 112 then accepts the user depressing the OK button 1104. The processing is then advanced to step S502.

In step S502, the overall processing unit 113 obtains the user ID and password having received input from the display unit 112. The overall processing unit 113 transmits the obtained user ID as a device user ID to the device user information managing unit 110. The device user information managing unit 110 transmits the device user information corresponding to the received device user ID to the overall processing unit 113. The overall processing unit 113 compares the received device user information and the password input by the user in step S501, and performs user ID and password authentication. In the case that the password input by the user and the device user password within the device user information match, determination is made that authentication has succeeded. In the case the passwords do not match, determination is made that authentication has failed. In the case that the overall processing unit 113 determines authentication failure, the processing returns to step S501. In the case the overall processing unit 113 determines authentication success, the processing is advanced to step S503. Let us say that the overall processing unit 113 has determined authentication success, and the flow is advanced to step S503.

In step S503, the overall processing unit 113 requests the display unit 112 to display a device processing screen 1401 shown in FIG. 14 to be described later, and accepts document temporary registration instruction input by a user. The display unit 112 displays the device processing screen 1401 shown in FIG. 14 to be described later according to the request. Next, settings at the time of original document scanning is input in the device processing screen 1401 shown in FIG. 14 to be described later by a size ratio button 1405, darkness button 1407, image quality button 1408, and duplex button 1408, and a transmit button 1412 is pressed. The processing then is advanced to step S504.

In step S504, the overall processing unit 113 requests all of the transmission destination information stored in the transmission destination information managing unit 111. Upon receiving the transmission destination from the transmission destination information managing unit 111 according to the request thereof, the overall processing unit 113 transmits the transmission destination information to the display unit 112, and requests display of a transmission destination selection screen 1501 shown in FIG. 15 to be described later. The display unit 112 displays a transmission destination selection screen 1501 shown in FIG. 15 to be described later.

Next, input of a transmission destination by the user is received in the transmission destination selection screen 1501 shown in FIG. 15. In FIG. 15, a transmission destination is input with a transmission destination selection radio button 1502. Further, the user ID of the document management server 101 is input in a transmission destination user ID input box 1506. Also, a password of the document management server 101 is input in a transmission destination password input box 1507. Also, a document saving folder name is input in a document saving folder input box 1508. Subsequently, the transmission destination selection screen 1501 accepts the user depressing the OK button 1509. The processing is then advanced to step S505.

In step S505, the overall processing unit 113 transmits the settings input at the time of scanning the original document by the user in step S503 to an unshown scanner in the image forming device 109, and requests a scan of the original document placed on the scan plate within the scanner. The document created by the scanner reading the original document and performing image processing according to the settings at the time of scanning the original document is received by the overall processing unit 113. The processing is advanced to step S506.

In step S506, the overall processing unit 113 transmits the document received in step S505 to the document management server 101. Also, the overall processing unit 113 transmits the device user ID of the image forming device 109 and the device user ID and device user email address within the device user information received in step S502 to the document management server 101. Further, the overall processing unit 113 transmits the transmission destination user ID input with the step S504 as the user ID of the document management server 101, and the transmission destination password as the password of the document management server 101, to the document management server 101. Further, the overall processing unit 113 transmits the document saving folder input by the user in step S504 to the document management server 101, and requests the document management server 101 to temporarily register the document. The processing is then advanced to step S507.

In step S507, the overall processing unit 113 determines whether or not the result of the document temporary registration request is received from the document management server 101. In the case the overall processing unit 113 determines that the result of the document temporary registration request is not received, the processing repeats step S507. In the case the overall processing unit 113 determines that the result of the document temporary registration request is received from the document management server 101, the processing is advanced to step S508. Here let us say that the overall processing unit 113 has received the result of the document temporary registration request from the document management server 101, and the processing is advanced to step S508.

In step S508, the overall processing unit 113 transmits the document temporary registration request result received in step S507 to the display unit 112, and requests display of a transmission result screen 1601 shown in FIG. 16 to be described later. The display unit 112 displays the transmission result screen 1601 shown in FIG. 16 to be described later on a liquid crystal display device 312. The processing of the flowchart shown in FIG. 5 is then ended.

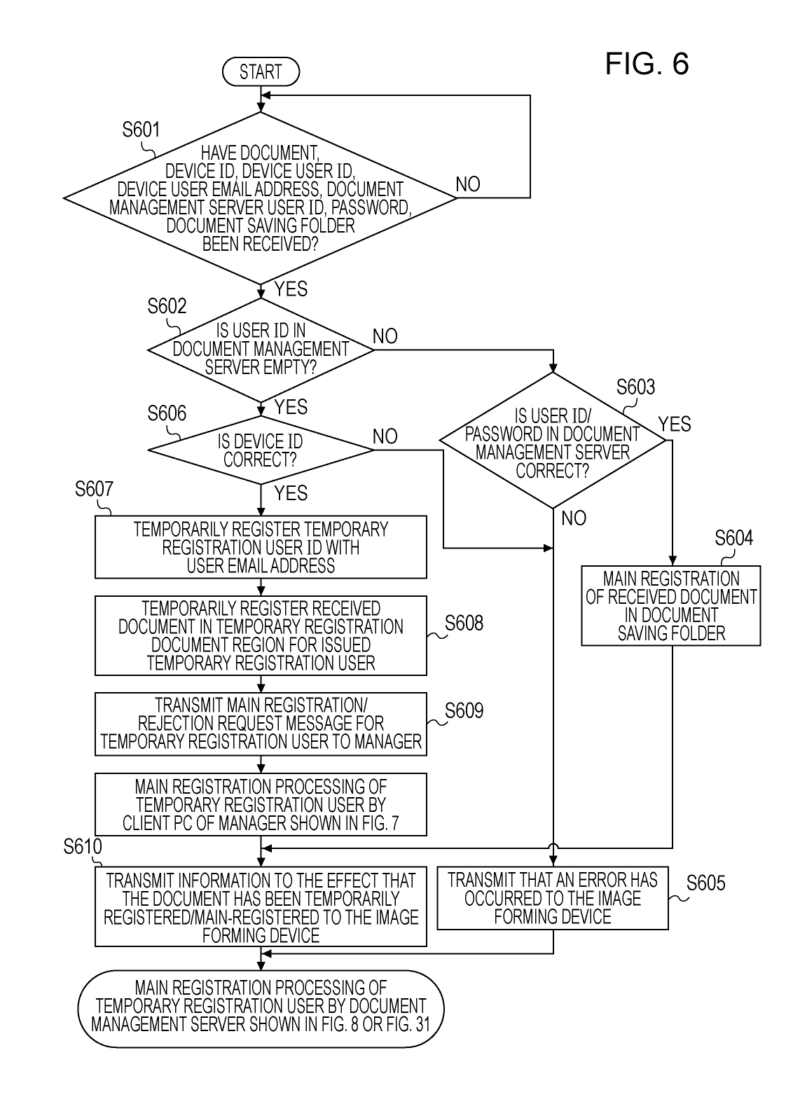

Upon the processing of the flowchart shown in FIG. 5 ending, document temporary registration processing is executed with the document management server shown in FIG. 6.

### Flowchart of Document Management Server at Time of Document Temporary Registration

Next, the document temporary registration processing with the document management server 101 will be described with reference to FIG. 6. FIG. 6 is a flowchart showing a sequence of document temporary registration processing with the document management server 101.

With the document management server 101, as shown in FIG. 6, first in step S601, a request processing unit 107 determines whether or not the document temporary registration request from the image forming device 109 is received. That is to say, the request processing unit 107 determines whether or not the document, device ID, device user ID, device user email address, document management server user ID, document management server password, and document saving folder name are received from the image forming device 109. In the case that the request processing unit 107 determines that the document temporary registration request is not received, the processing repeats step S601. In the case that the request processing unit 107 determines that the document temporary registration request is received, the processing is advanced to step S602. Here let us say that request processing unit 107 determines that the document temporary registration request is received, and the processing is advanced to step S602.

In step S602, the request processing unit 107 determines whether or not the document management server user ID received in step S601 is blank. In the case the request processing unit 107 determines that the document management server user ID received in step S601 is not blank, the processing is advanced to step S603.

In the case the request processing unit 107 determines that the document management server user ID received in step S601 is blank, the processing is advanced to step S606. Here let us say that the document management server user ID received in step S601 is not blank, and the processing is advanced to step S603.

In step S603, the request processing unit 107 authenticates the user ID and password received in step S601. The request processing unit 107 transmits the user ID received in step S601 to the user information managing unit 102. The user information managing unit 102 transmits the user information as to the user ID received to the request processing unit 107. The request processing unit 107 determines whether or not the password within the received user information and the password received in step S601 match, and also whether the management flag of the user information is “1”, i.e. is a manager. In the case that the request processing unit 107 determines that the password in the user information received from the user information managing unit 102 matches the password received in step S601, and is a manager, the processing is advanced to step S604 as the authentication having succeeded. In the case the request processing unit 107 determines otherwise, the processing is advanced to step S605 as the authentication having failed. Here let us say that the request processing unit 107 has determined the authentication to have succeeded, and the processing is advanced to step S604.

In step S604, the request processing unit 107 transmits the document received in step S601 to the document saving folder received in step S601 and the user information received in step S603 to the document information managing unit 105, and requests the document to be saved. The document information managing unit 105 saves the document received from the request processing unit 107 in the document folder having the received document folder name, stores the document information, and main-registers the document. The document information managing unit 105 transmits a message to the effect that the document has been saved to the request processing unit 107. Upon the request processing unit 107 receiving the message to the effect that the document has been saved, the processing is advanced to step S610.

In step S605, the request processing unit 107 transmits a message to the image forming device 109 to the effect that an error has occurred in the saving of the document. The processing in the flowchart shown in FIG. 6 is then ended.

In step S606, the request processing unit 107 authenticates the device ID received in step S601. The request processing unit 107 transmits the device ID received in step S601 to the device information managing unit 103, and requests a readout of the device information as to the device ID. The device information managing unit 103 reads out the device information as to the received device ID and transmits this to the request processing unit 107, and the request processing unit 107 receives the device information. In the case the request processing unit 107 determines that the device information corresponding to the device ID is not read out, the processing is advanced to step S605 as the authentication having failed. In the case the request processing unit 107 determines that the device information corresponding to the device ID is read, the processing is advanced to step S607 as the authentication having succeeded. Here let us say that the device information corresponding to the device ID is read, and the processing is advanced to step S607 as the authentication having succeeded.

In step S607, the request processing unit 107 performs temporary registration of the user information. That is to say, the request processing unit 107 transmits the device user email address received in step S601 to the temporary registration user information managing unit 104, and requests temporary registration of the user information. The temporary registration user information managing unit 104 stores the received device user email address as the temporary registration user information, and transmits a message to the effect that the temporary registration user information has been stored and the stored temporary registration user information to the request processing unit 107. Upon the request processing unit 107 receiving the message to the effect that the temporary registration user information has been stored and the stored temporary registration user information, the processing is advanced to step S608.

In step S608, the request processing unit 107 transmits the temporary registration user information received in step S607 and the document received in step S601 to the temporary registration document information managing unit 106, and requests storage of the temporary registration document information. The temporary registration document information managing unit 106 saves the document received from the request processing unit 107 in a folder determined beforehand. The temporary registration document information managing unit 106 stores the temporary registration user information and document as information in an associated state (temporary registration document information), and transmits a message to the effect that the temporary registration document information has been stored and the stored temporary registration document information to the request processing unit 107. Upon receiving the message to the effect that the temporary registration document information has been stored and the stored temporary registration document information is received, the request processing unit 107 advances the processing to step S609.

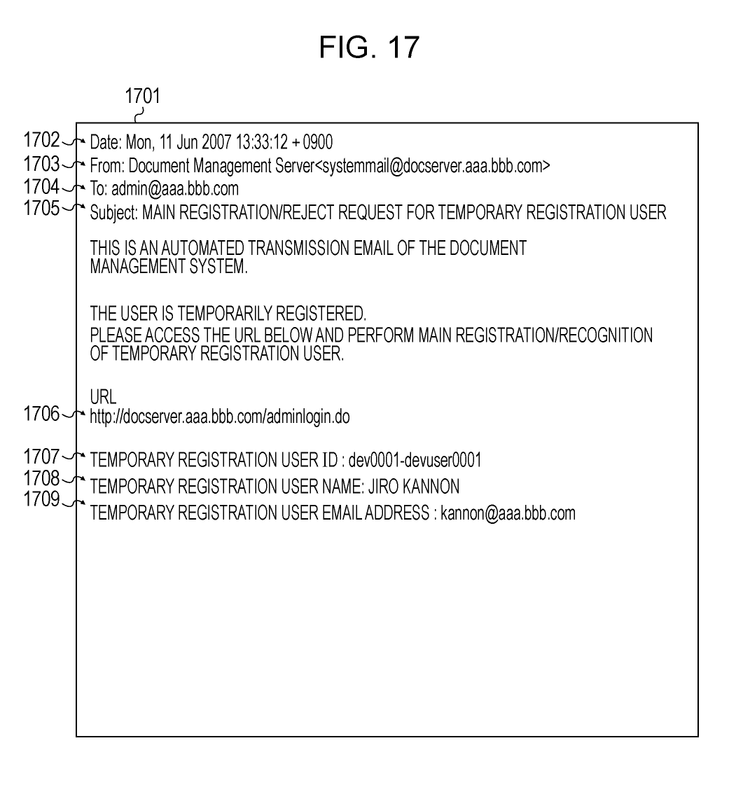

In step S609, the request processing unit 107 transmits a temporary registration user main registration/rejection request email shown in FIG. 17 to be described later to the manager of the document management server 101. First, the request processing unit 107 requests the user information managing unit 102 to read the user information of a manager, i.e. a user wherein the manager flag of the user information is “1”. The user information managing unit 102 reads the user information of the user wherein the managing flag in the user information is “1”, and transmits this to the request processing unit 107. The request processing unit 107 receives user information from the user information managing unit. Further, the request processing unit 107 uses the temporary registration user information received in step S607 to transmit the temporary registration main registration/rejection request email 1701 shown in FIG. 17 to be described later addressed to the received user information email address.

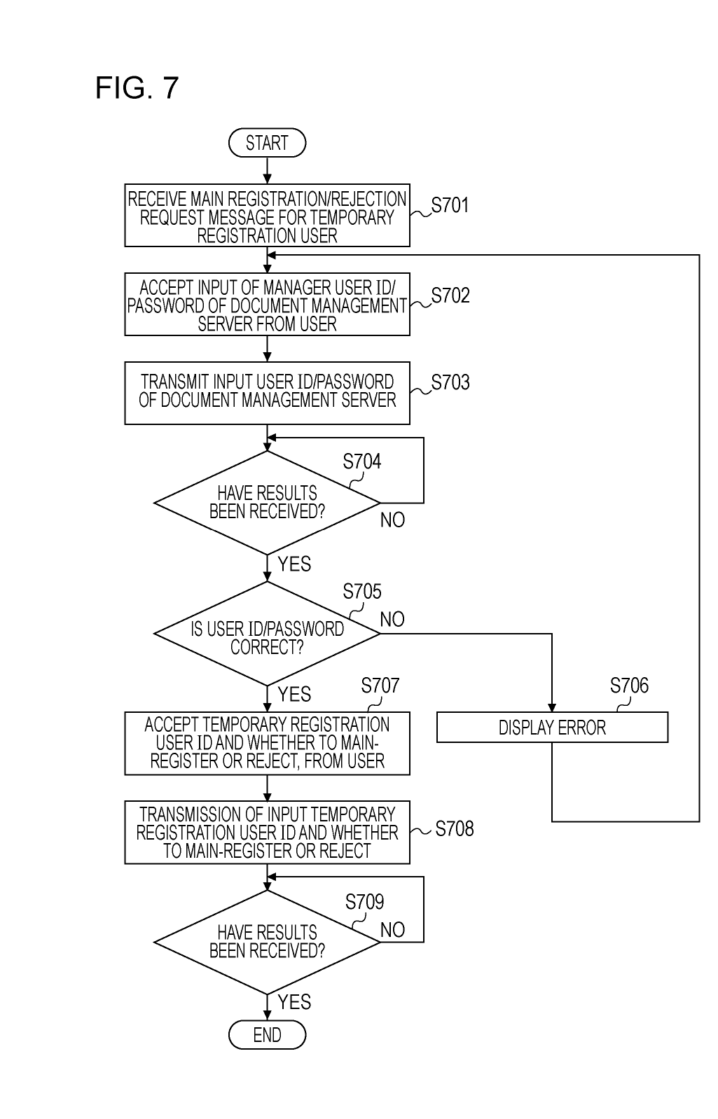

Upon the processing in step S609 ending, main registration processing of the temporary registration user is executed by the client PC of the manager shown in FIG. 7. The processing is then advanced to step S610. In step S610, the request processing unit 107 transmits a message to the image forming device 109 to the effect that the document has been temporarily registered or main-registered. The processing in the flowchart shown in FIG. 6 is ended.

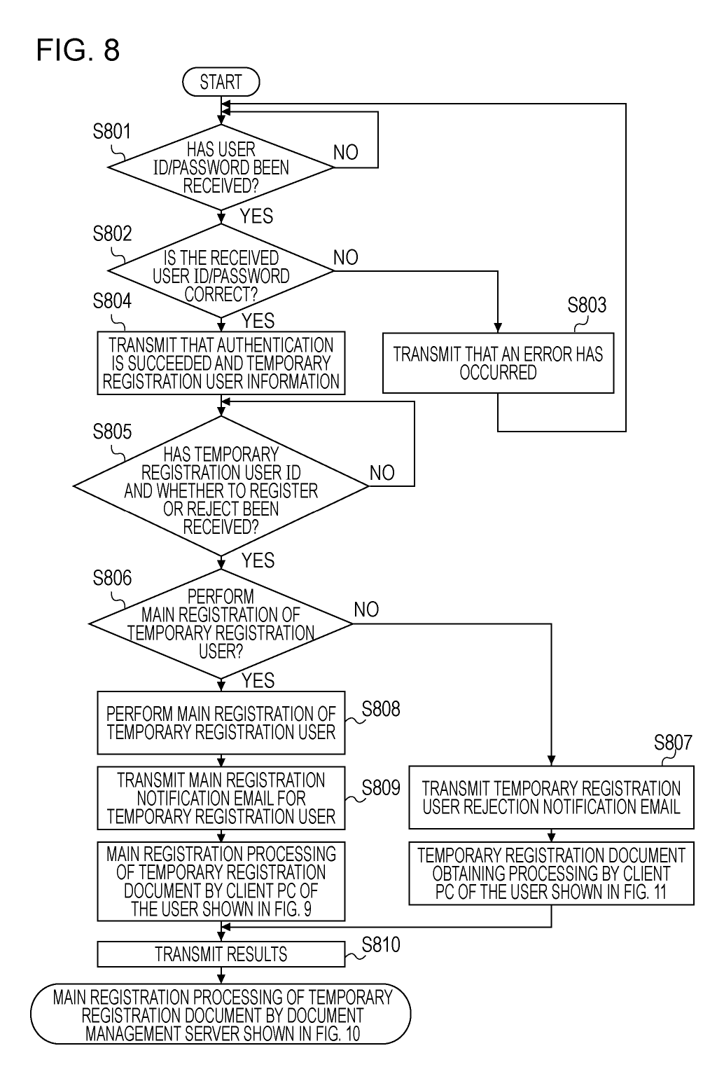

Upon the processing in the flowchart shown in FIG. 6 ending, the main registration processing of the temporary registration user is executed by the document management server shown in FIG. 8.

### Flowchart of Client PC at Time of Temporary Registration User Main Registration/Rejection

Next, the main registration processing of the temporary registration user with the client PC 114 will be described with reference to FIG. 7. FIG. 7 is a flowchart showing a sequence of the main registration processing of the temporary registration user with the client PC 114. This sequence is executed with an unshown CPU.

As shown in FIG. 7, in step S701, the overall processing unit 116 receives the temporary registration user main registration/rejection request email 1701 shown in FIG. 17 to be described later with the client PC 114. The temporary registration user main registration/rejection request email 1701 is transmitted from the document management server 101 addressed to the email address of the manager. The processing is then advanced to step S702.

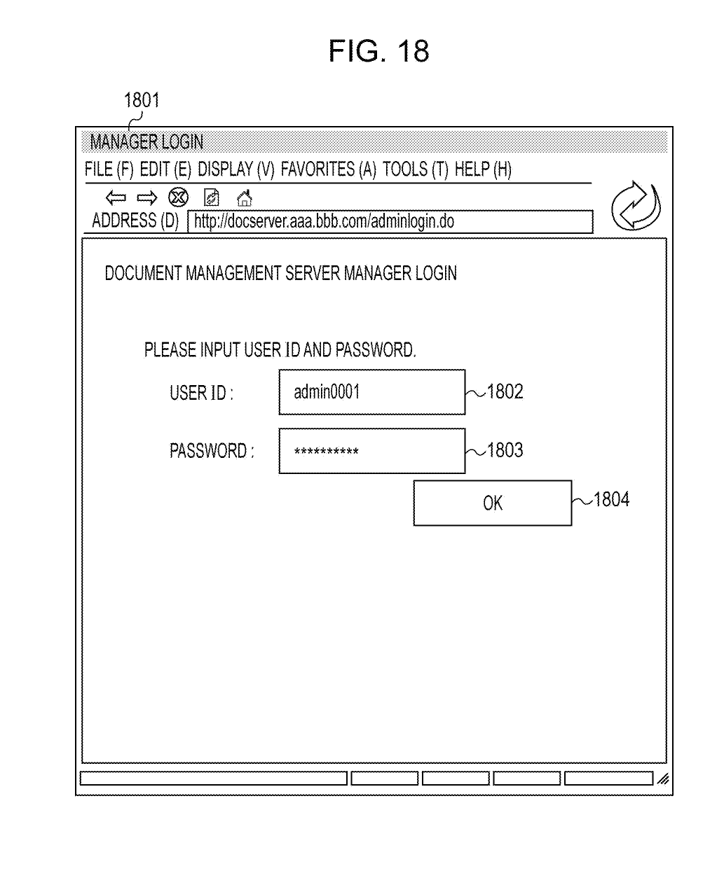

In step S702, the overall processing unit 116 obtains a manager login screen URL 1706 in the temporary registration user main registration/rejection request email 1701 shown in FIG. 17 to be described later, received in step S701 in response to input from the user. The overall processing unit 116 requests the manager login screen URL 1706 to receive a manager login screen 1801 shown in FIG. 18 to be described later. Upon receiving the manager login screen 1801 shown in shown in FIG. 18 to be described later, the overall processing unit 116 requests the display unit 115 to display the manager login screen 1801 shown in FIG. 18 to be described later. The display unit 115 displays the manager login screen 1801 shown in FIG. 18 to be described later on an unshown CRT in response to the request. Next, the manager login screen 1801 shown in FIG. 18 to be described later accepts input of a user ID and password by the user from user ID input box 1802 and password input box 1803. Upon the manager login screen 1801 accepting the user pressing the OK button 1804, the overall processing unit 116 accepts the input user ID and password. The processing is then advanced to step S703.

In step S703, the overall processing unit 116 transmits the user ID and password received in step S702 to the document management server 101. The processing is then advanced to step S704.

In step S704, the overall processing unit 116 determines whether or not the authentication result is received from the document management server 101. In the case the overall processing unit 116 determines that the authentication result is not received from the document management server 101, the processing repeats step S704. In the case the overall processing unit 116 determines that authentication result is received from the document management server 101, the processing is advanced to step S705. Here let us say that the authentication result is received from the document management server 101, and the processing is advanced to step S705.

In step S705, the overall processing unit 116 determines whether or not the authentication result received in step S704 is an authentication success. In the case the authentication result received in step S704 is not an authentication success, the processing is advanced to step S706.

In the case the overall processing unit 116 determines that the authentication result received in step S704 is an authentication success, the processing is advanced to step S707. Here let us say that the overall processing unit 116 determines that the authentication result received in step S704 is not an authentication success, and the processing is advanced to step S706.

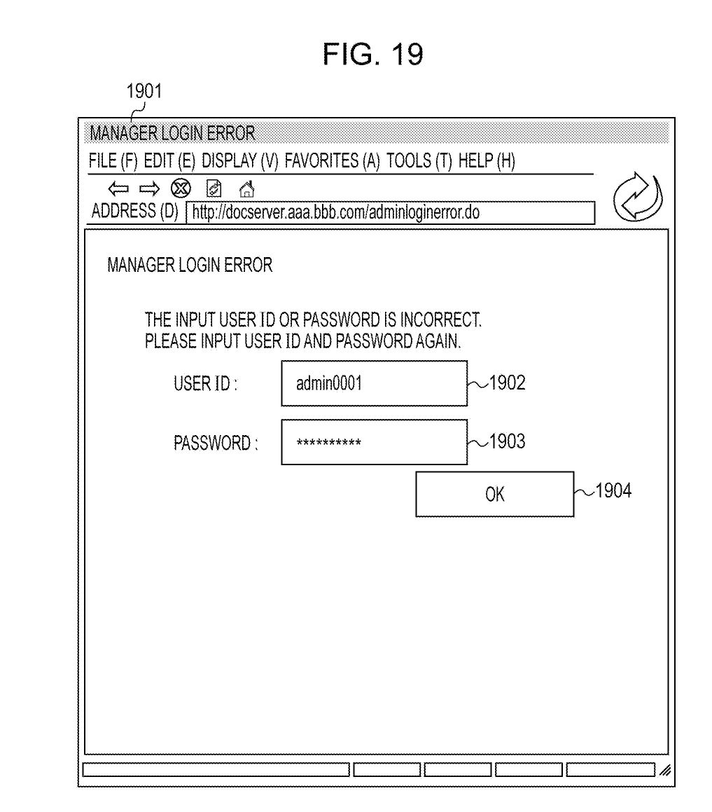

In step S706, the overall processing unit 116 requests the display unit 115 to display a manager login error screen 1901 shown in FIG. 19 to be described later. The display unit 115 displays the manager login error screen shown in FIG. 19 to be described later, according to the request thereof. The processing then is advanced to step S702.

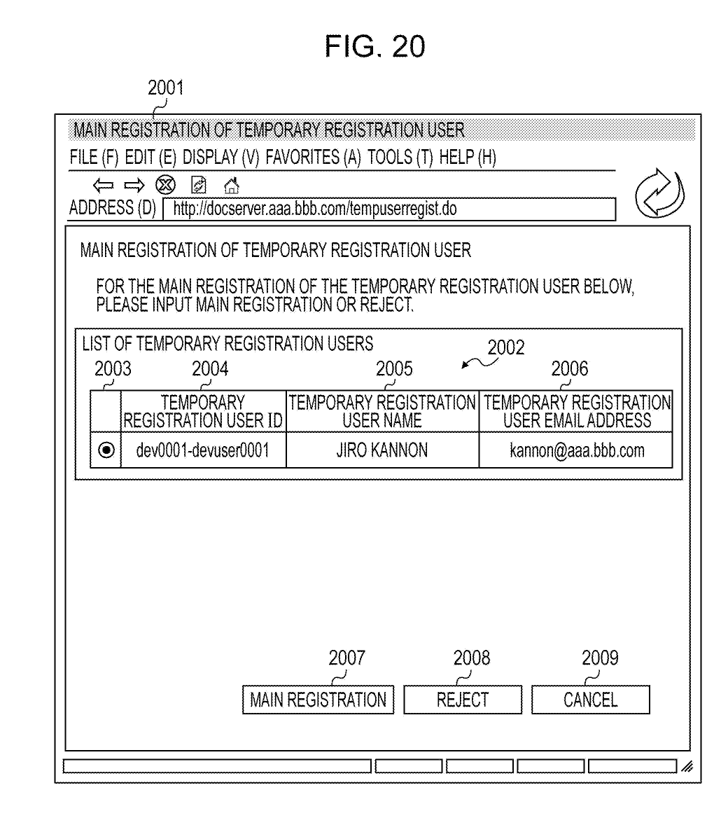

In step S707, the overall processing unit 116 requests the display unit 115 to display a temporary registration user main registration screen 2001 shown in FIG. 20 to be described later. The display unit 115 displays the temporary registration user main registration screen 2001 shown in FIG. 20 to be described later, according to the request thereof. The overall processing unit 116 accepts input of the temporary registration user ID of the temporary registration user by the user from the temporary registration user selection radio button 2003 of the temporary registration user main registration screen 2001 shown in FIG. 20 to be described later. Further, the overall processing unit 116 accepts the user pressing a main registration button 2007 or reject button 2008 in the temporary registration user main registration screen 2001 shown in FIG. 20 to be described later. The processing then is advanced to step S708.

In step S708, the overall processing unit 116 transmits a message of either main registration or rejection of the temporary registration user to the document management server 101. First, the overall processing unit 116 determines which of the main registration button 2007 and reject button 2008 is the button obtained in step S707. In the case that the main registration button 2007 is pressed, the overall processing unit 116 determines that the selection thereof is main registration. In the case that the reject button 2008 is pressed, the overall processing unit 116 determines that the selection thereof is rejection. The overall processing unit 116 transmits the temporary registration user ID obtained in step S707 and the selection of main registration or rejection to the document management server 101. The processing is then advanced to step S709.

In step S709, the overall processing unit 116 determines whether or not the result of temporary registration user main registration or rejection is received from the document management server 101. In the case the overall processing unit 116 determines that the result of temporary registration user main registration or rejection is not received, the processing repeats step S709. In the case the overall processing unit 116 determines that the result of the temporary registration user main registration or rejection is received, the processing in the flowchart shown in FIG. 7 is ended. Here let us say that the overall processing unit 116 determines that the result of the temporary registration user main registration or rejection is received, and the processing in the present flowchart is ended.

### Flowchart of Document Management Server at Time of Temporary Registration User Main Registration/Rejection>

Next, the temporary registration user main registration processing by the document management server 101 will be described with reference to FIG. 8. FIG. 8 is a flowchart showing a sequence for the temporary registration user main registration processing by the document management server 101. This sequence is executed by an unshown CPU.

The document management server 101 determines whether or not the request processing unit 107 has received the user ID and password from the client PC 114 in step S801 as shown in FIG. 8. In the case the request processing unit 107 determines that the user ID and password are not received from the client PC 114, the processing repeats step S801. In the case the request processing unit 107 determines that the user ID and password are received from the client PC 114, the processing is advanced to step S802. Here let us say that the user ID and password are received from the client PC 114, and the processing is advanced to step S802.

In step S802, the request processing unit 107 authenticates the user ID and password received in step S801. The request processing unit 107 transmits the user ID received in step S801 to the user information managing unit 102, and requests the user information corresponding to the user ID to be read. The user information managing unit 102 reads the user information corresponding to the received user ID, and transmits this to the request processing unit 107. In the case that the request processing unit 107 determines that the password of the user information received from the user information managing unit 102 and the password received in step S801 matches, the request processing unit 107 determines authentication to have succeeded, and the processing is advanced to step S804. In the request processing unit 107 determines otherwise, authentication is determined to have failed, and the processing is advanced to step S803. Here let us say that determination is made that the authentication did not succeed, and the processing is advanced to step S803.

In step S803, the request processing unit 107 transmits a message to the client PC 114 to the effect that an authentication error has occurred. The processing is returned to step S801.

In step S804, the request processing unit 107 first requests the temporary registration user information managing unit 104 to read out all of the temporary registration user information. The temporary registration user information managing unit 104 reads out all of the temporary registration user information, and transmits this to the request processing unit 107. The request processing unit 107 transmits the received temporary registration user information and the message to the effect that the authentication has succeeded to the client PC 114. The processing is then advanced to step S805.

In step S805, the request processing unit 107 determines whether or not the temporary registration user ID and the selection of main registration or rejection are received from the client PC 114. In the case the request processing unit 107 determines that the temporary registration user ID and the selection of main registration or rejection are not received, the processing repeats step S805. In the case the request processing unit 107 determines that the temporary registration user ID and the selection of main registration or rejection are received, the processing is advanced to step S806. Here let us say that the temporary registration user ID and the selection of main registration or rejection are received, and the processing is advanced to step S806.

In step S806, the request processing unit 107 determines whether the selection of main registration or rejection received in step S805 is main registration or rejection. In the case that the request process unit 107 determines that the selection of main registration or rejection received in step S805 is rejection, the processing is advanced to step S807. In the case that the request process unit 107 determines that the selection of main registration or rejection received in step S805 is main registration, the processing is advanced to step S808. Here let us say that the request process unit 107 determines that the selection of main registration or rejection received in step S805 is rejection, and the processing is advanced to step S807.

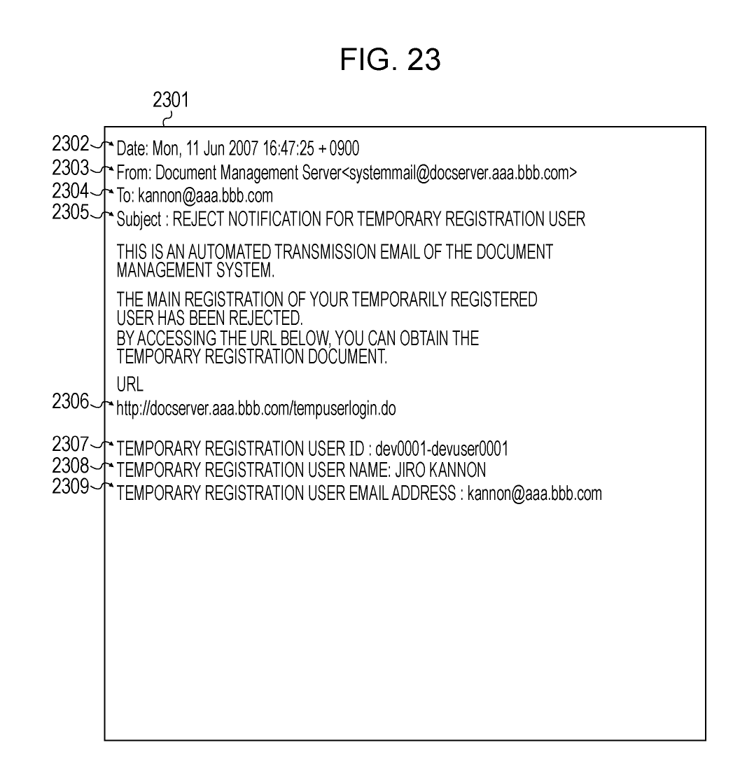

In step S807, the request processing unit 107 transmits a temporary registration user rejection notification email 2301 shown in FIG. 23 to be described later addressed to the temporary registration user email address of the temporary registration user ID received in step S805. First, the request processing unit 107 transmits the temporary registration user ID received in step S805 to the temporary registration user information managing unit 104, and requests the temporary registration user information as to the temporary registration user ID to be read out. The temporary registration user information managing unit 104 reads out the temporary registration user information as to the received temporary registration user ID, and transmits this to the request processing unit 107. Further, in step S807, the request processing unit 107 transmits the temporary registration user rejection notification email 2301 shown in FIG. 23 to be described later addressed to the email address of the received temporary registration user information.

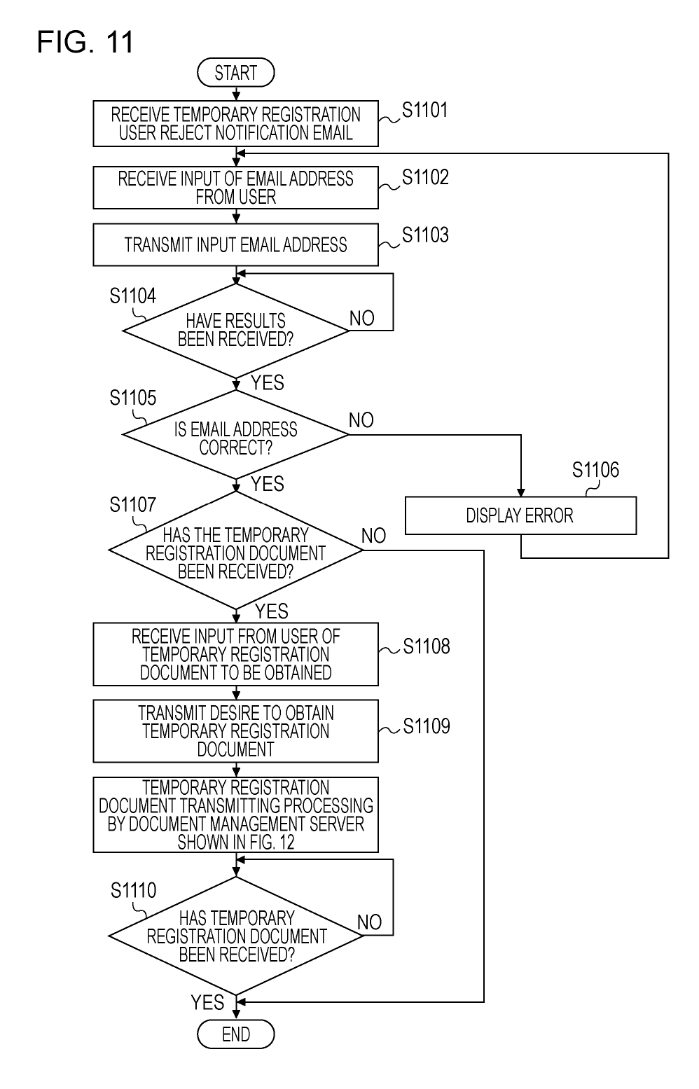

Upon the processing in step S807 ending, temporary registration document obtaining processing by the user client PC shown in FIG. 11 is executed. Subsequently, the processing is advanced to step S810.

In step S808, the request processing unit 107 main-registers the temporary registration user of the temporary registration user ID received in step S805 as the user. First, the request processing unit 107 transmits the temporary registration user ID received in step S805 to the temporary registration user information managing unit 104. The temporary registration user information managing unit 104 transmits the temporary registration user information to the request processing unit 107. Further, the request processing unit 107 transmits the received temporary registration user information to the user information managing unit 102 to request main registration. The user information managing unit 102 main-registers the received temporary registration user information as the user information, and transmits a message to the effect that the user has been registered and the user information to the request processing unit 107.

In the case that the received temporary registration user information is main-registered as user information, the document associated with the temporary registration user ID and stored is associated with the main-registered user ID. The request processing unit 107 receives the message to the effect that the user has been registered and the user information from the user information managing unit 102. The processing is then advanced to step S809.

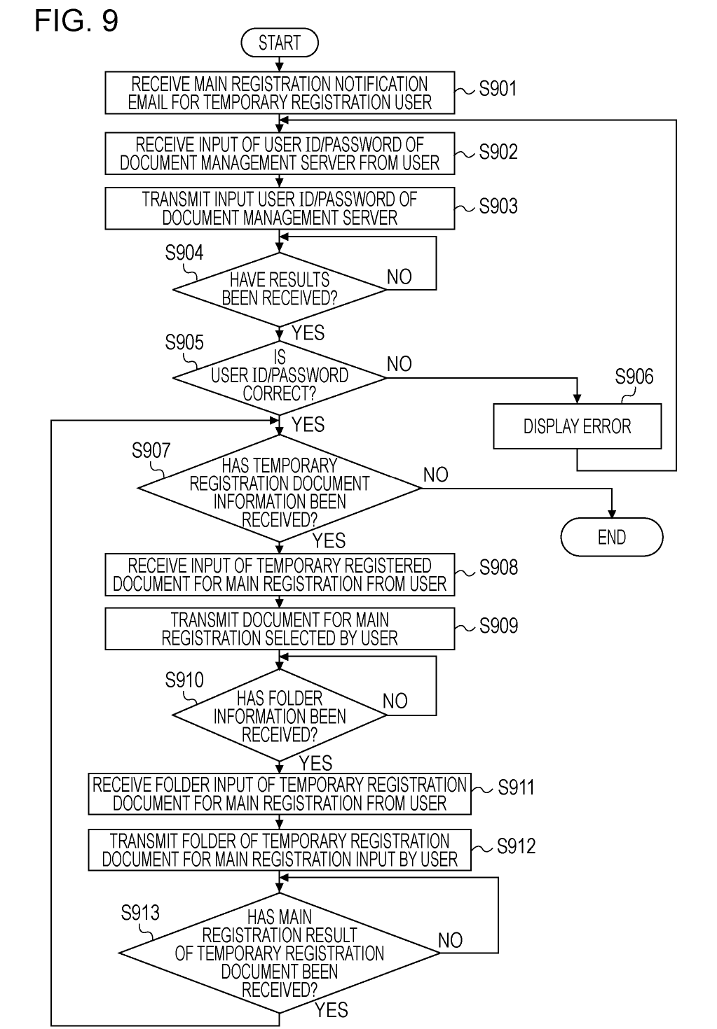

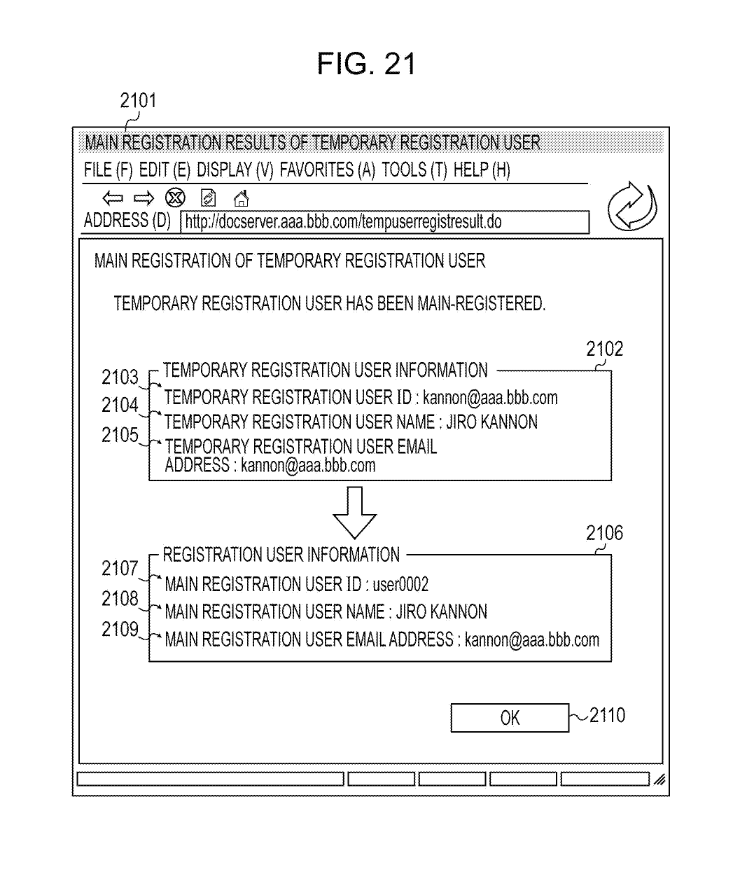

In step S809, the request processing unit 107 transmits a main registration notification email 2201 for the temporary registered user shown in FIG. 21 to be described later, addressed to the email address of the user information received in step S808. Upon the processing in step S809 ending, the main registration processing of the temporary registration document with the client PC of the user shown in FIG. 9 is executed. The processing is then advanced to step S810.

In step S810, the request processing unit 107 transmits the processing result from step S807 or step S809 to the client PC 114. The processing in the flowchart shown in FIG. 8 is then ended.

### Flowchart of Client PC at Time of Temporary Registration Document Main Registration

Next, the main registration processing of the temporary registration document by the client PC 114 will be described with reference to FIG. 9. FIG. 9 is a flowchart showing a sequence of the main registration processing of the temporary registration document by the client PC 114. This sequence is executed with an unshown CPU.

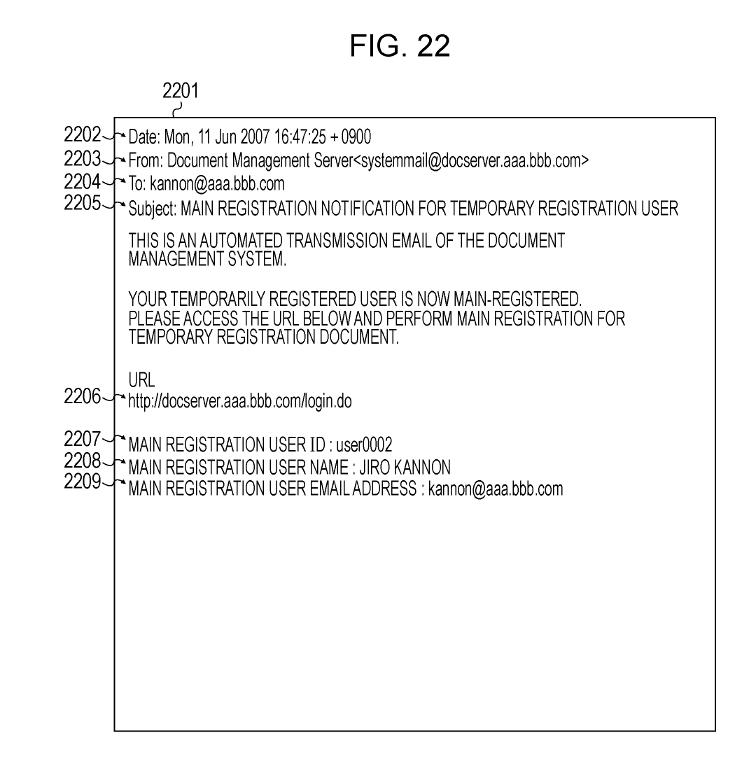

With the client PC 114, as shown in FIG. 9, first in step S901 the overall processing unit 116 receives a temporary registration user main registration notification email 2201 shown in FIG. 22 which is transmitted from the document managing server 101 addressed to the email address of the user. The processing is then advanced to step S902.

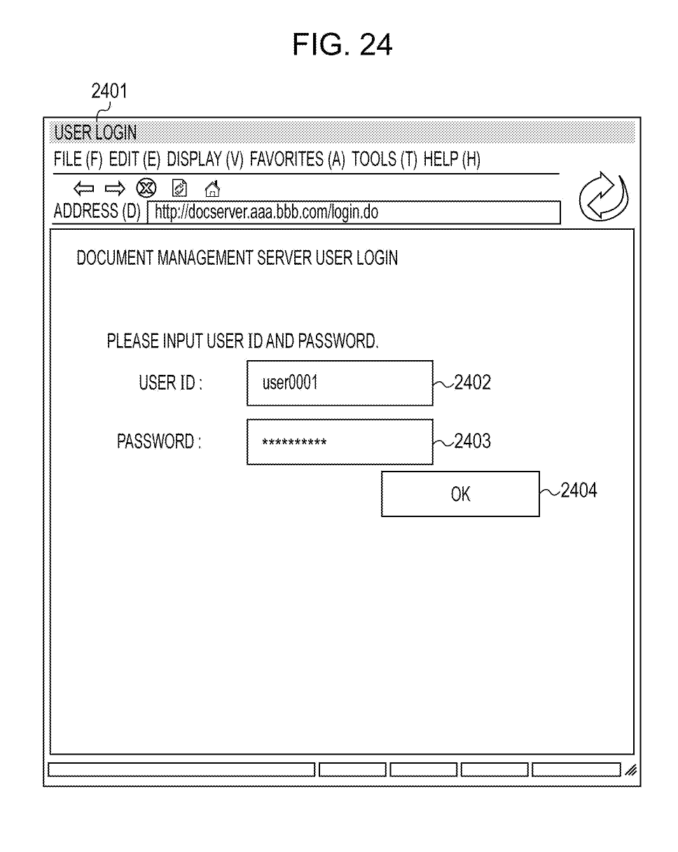

In step S902, the overall processing unit 116 obtains a user login screen URL 2206 in the temporary registration user main registration notification email 2201 shown in FIG. 22 to be described later which is received in step S901, according to user input. The overall processing unit 116 requests reception of a user logic screen 2401 shown in FIG. 24 to be described later from the user login screen URL 2206. Upon receiving the user login screen 2401 shown in FIG. 24 to be described later, the overall processing unit 116 requests the display unit 115 to display the user login screen 2401 shown in FIG. 24 to be described later. The display unit 115 displays the user login screen 2401 shown in FIG. 24 to be described later on an unshown CRT in accordance with the request thereof. Next, the user login screen 2401 shown in FIG. 24 to be described later receives input of the user ID and password by the user from the user ID input box 2402 and password input box 2403. Upon the user login screen 2401 accepting the user pressing the OK button 2404, the overall processing unit 116 obtains the input user ID and password. The processing is then advanced to step S903.

In step S903, the overall processing unit 116 transmits the user ID and password obtained in step S902 to the document managing server 101. The processing then is advanced to step S904.

In step S904, the overall processing unit 116 determines whether or not the authentication result is received from the document managing server 101. In the case the overall processing unit 116 determines that the authentication result is not received from the document managing server 101, the processing repeats step S904. In the case the overall processing unit 116 determines that the authentication result is received from the document managing server 101, the processing is advanced to step S905. Here let us say that the authentication result is received from the document managing server 101, and the processing is advanced to step S905.

In step S905, the overall processing unit 116 determines whether or not the authentication result received in step S904 is an authentication success. In the case the overall processing unit 116 determines that the authentication result received in step S904 is not an authentication success, the processing is advanced to step S906. In the case the overall processing unit 116 determines that the authentication result received in step S904 is an authentication success, the processing is advanced to step S907. Here let us say that the authentication result received in step S904 is not an authentication success, and the processing is advanced to step S906.

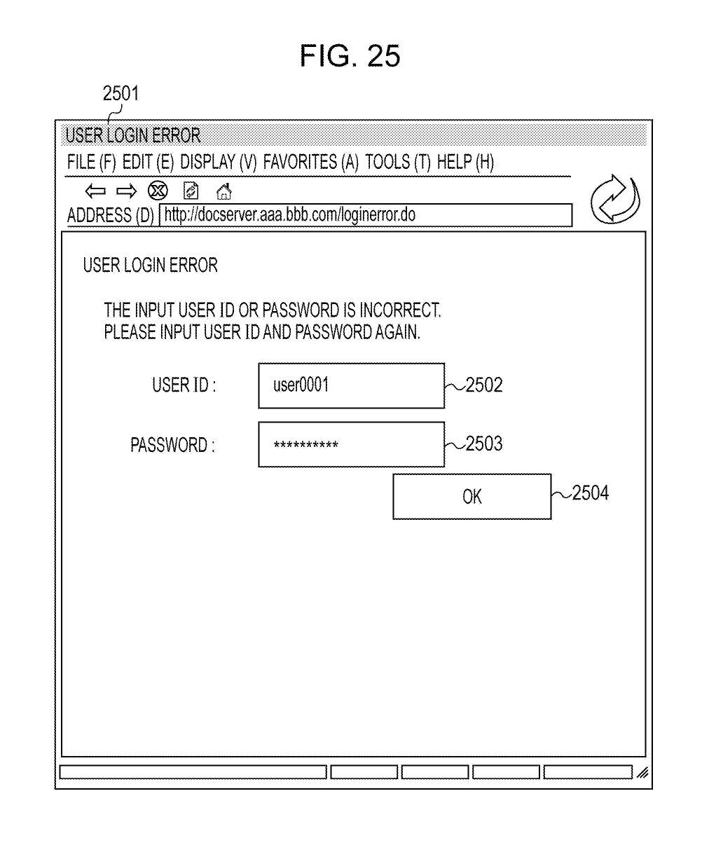

In step S906, the overall processing unit 116 requests the display unit 115 to display a user login error screen 2501 shown in FIG. 25 to be described later. The display unit 115 displays the user login error screen 2501 shown in FIG. 25 to be described later on an unshown CRT according to the request thereof. The processing is then advanced to step S902.

In step S907, the overall processing unit 116 determines whether or not the temporary registration has received document information from the document managing server 101 in step S904. In the case the overall processing unit 116 has not received the temporary registration document information in step S904, the processing in the flowchart shown in FIG. 9 is ended. In the case the overall processing unit 116 has received the temporary registration document information in step S904, the processing is advanced to step S908. Here let us say that the overall processing unit 116 has received the temporary registration document information in step S904, and the processing is advanced to step S908.

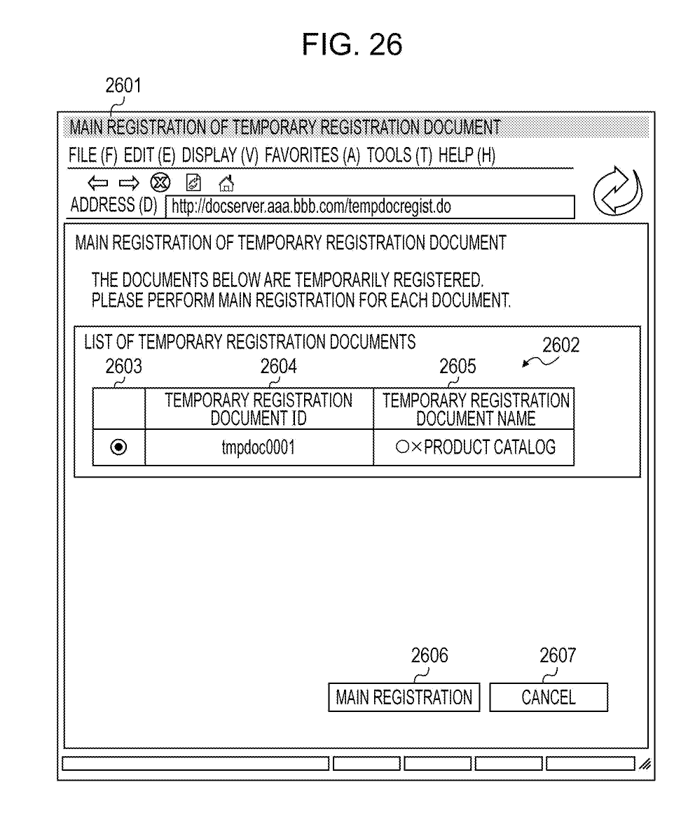

In step S908, the overall processing unit 116 requests the display unit 115 to display a temporary registration document main registration screen 2601 shown in FIG. 26 to be described later. The display unit 115 displays the temporary registration document main registration screen 2601 shown in FIG. 26 to be described later on an unshown CRT according to the request thereof, and accepts input of the temporary registration document by the user. In the event that a main registration button 2606 is input by the user, the overall processing unit 116 obtains a temporary registration document ID of the temporary registration document selected with the temporary registration document selection radio button 2603 on the temporary registration document main registration screen 2601. The processing is then advanced to step S909.

In step S909, the overall processing unit 116 transmits the temporary registration user ID obtained in step S908 and a message to the effect that the temporary registration document is main-registered, to the document managing server 101. The processing is then advanced to step S910.

In step S910, the overall processing unit 116 determines whether or not folder information from the document managing service 101 is received. In the case the overall processing unit 116 determines that the folder information is not received, the processing repeats step S910. In the event the overall processing unit 116 determines that the folder information is received, the processing is advanced to step S911. Here let us say that the folder information is received, and the processing is advanced to step S911.

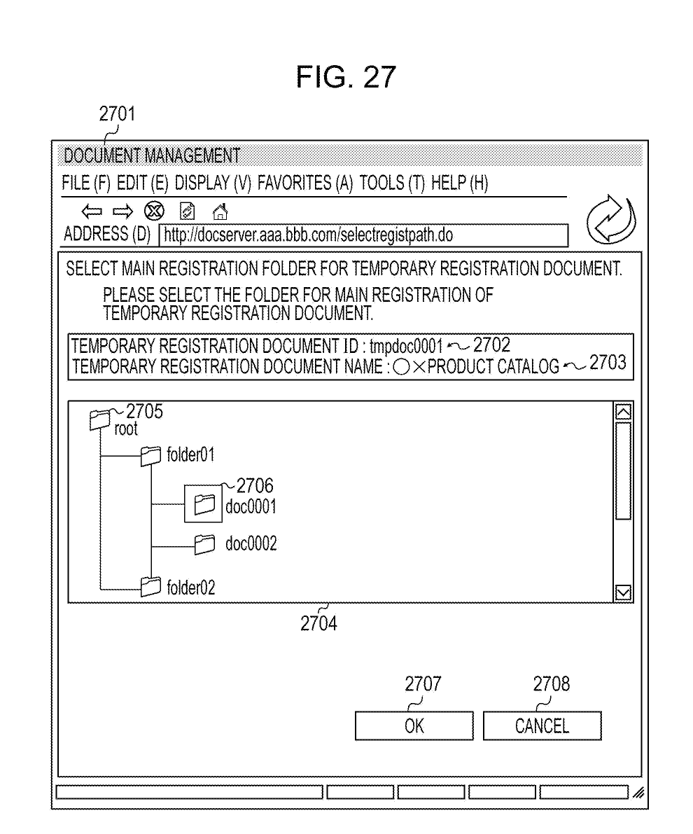

In step S911, the overall processing unit 116 transmits the folder information received in step S910 to the display unit 115, and requests a display of a temporary registration document main registration folder selection screen 2701 shown in FIG. 27 to be described later. The display unit 115 displays the temporary registration document main registration folder selection screen 2701 shown in FIG. 27 to be described later on an unshown CRT according to the request thereof. In the event that the OK button 2707 is input by a user, the overall processing unit 116 obtains folder information of a folder 2705 selected with the selection folder 2706 of the temporary registration document main registration folder selection screen 2701 shown in FIG. 27 to be described later. The processing is then advanced to step S912.

In step S912, the overall processing unit 116 transmits the folder information obtained in step S911 to the document managing server 101. The processing is advanced to step S913.

In step S913, the overall processing unit 116 determines whether or not the temporary registration document main registration result is received from the document managing server 101. In the case the overall processing unit 116 determines that the temporary registration document main registration result is not received, the processing repeats steps S913. In the case the overall processing unit 116 determines that the temporary registration document main registration result is received, the processing is returned to step S907.

### Flowchart of Document Managing Server at Time of Temporary Registration Document Main Registration

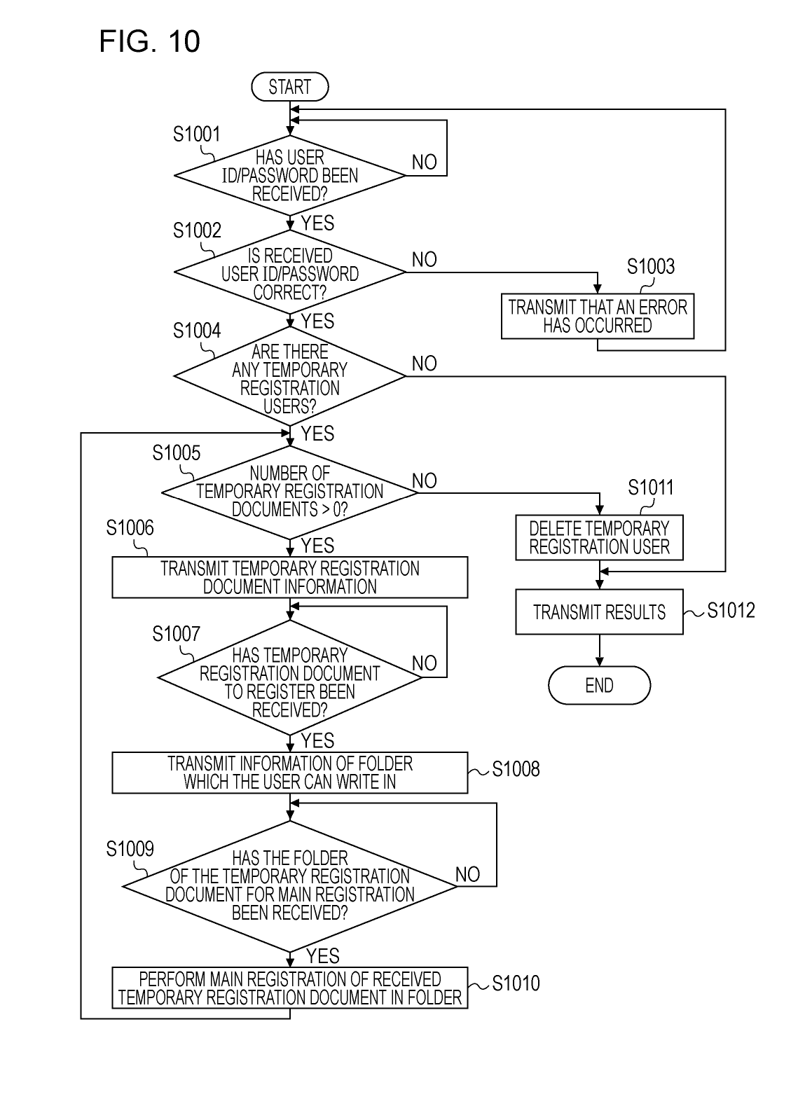

Next, the temporary registration document main registration processing by the document managing server 101 will be described with reference to FIG. 10. FIG. 10 is a flowchart showing a sequence of the temporary registration document main registration by the document managing server 101. This sequence is executed with an unshown CPU.

With the document managing server 101, as shown in FIG. 10, first in step S1001 the request processing unit 107 determines whether or not a user ID and password from the client PC 114 have been received. In the event the request processing unit 107 determines that the user ID and password are not received from the client PC 114, the processing repeats step S1001. In the event the request processing unit 107 determines that the user ID and password are received from the client PC 114, the processing is advanced to step S1002. Here let us say that the request processing unit 107 determines that the user ID and password are received from the client PC 114, and the processing is advanced to step S1002.

In step S1002, the request processing unit 107 authenticates the user ID and password received in step S1001. The request processing unit 107 transmits the user ID received in step S1001 to the user information managing unit 102, and requests the user information corresponding to the user ID to be read out. The user information managing unit 102 reads out the user information as to the received user ID, and transmits this to the request processing unit 107. The request processing unit 107 determines whether or not the password of the received user information and the password received in step S1001 match. In the case that the password of the user information received from the user information managing unit 102 and the password received in step S1001 match, the processing is advanced to step S1004 as the authentication having succeeded. In the case that the request processing unit 107 determines otherwise, the processing is advanced to step S1003 as the authentication having failed. Here let us say that the request processing unit 107 determines that the authentication is not a success, and the processing is advanced to step S1003.

In step S1003, the request processing unit 107 transmits a message to the effect that an authentication error has occurred to the client PC 114. The processing is then returned to step S1001.

In step S1004, the request processing unit 107 transmits the email address of the user information received in step S1002 to the temporary registration user information managing unit 104, and requests the temporary registration user information to be read out wherein the email address serves as the temporary registration user ID. The temporary registration user information managing unit 104 reads out the temporary registration user information wherein the received email address serves as the temporary registration user ID, and transmits this to the request processing unit 107. Subsequently, the request processing unit 107 determines whether or not the temporary registration user information is received from the temporary registration user information managing unit 104. In the case the request processing unit 107 determines that the temporary registration user information is received from the temporary registration user information managing unit 104, the processing is advanced to step S1005, as temporary registration user information existing. In the case the request processing unit 107 determines that the temporary registration user information is not received from the temporary registration user information managing unit 104, the process is advanced to step S1012 as temporary registration user information not existing. Here let us say that the request processing unit 107 determines that the temporary registration user information is received from the temporary registration user information managing unit 104, and the processing is advanced to step S1005, as temporary registration user information existing.

In step S1005, the request processing unit 107 transmits the temporary registration user ID of the temporary registration user information received in step S1004 to the temporary registration document information managing unit 106, and requests the temporary registration document information associated with the temporary registration user ID to be read out. The temporary registration information managing unit 106 reads out the temporary registration document information associated with the received temporary registration user ID, and transmits this to the request processing unit 107. Subsequently, the request processing unit 107 receives the temporary registration document information from the temporary registration document information managing unit 106, and determines whether or not the number of temporary registration documents of the temporary registration document information received is greater than 0. In the case that the request processing unit 107 determines that the number of temporary registration documents of the temporary registration document information received from the temporary registration document information managing unit 106 is greater than 0, the process is advanced to step S1006. In the case that the request processing unit 107 determines that the number of temporary registration documents of the temporary registration document information received from the temporary registration document information managing unit 106 is not greater than 0, the process is advanced to step S1011. Here let us say that the request processing unit 107 determines that the number of temporary registration documents of the temporary registration document information received from the temporary registration document information managing unit 106 is greater than 0, and the process is advanced to step S1006.

In step S1006, the request processing unit 107 transmits the temporary registration document information received in step S1005 to the client PC 114. The processing is then advanced to step S1007.

In step S1007, the request processing unit 107 determines whether or not the temporary registration document ID and a message to the effect that the temporary registration document has been registered is received from the client PC 114. In the case that the request processing unit 107 determines that the temporary registration document ID and the message to the effect that the temporary registration document has been registered is not received, the processing repeats step S1007. In the case that the request processing unit 107 determines that the temporary registration document ID and the message to the effect that the temporary registration document has been registered is received, the processing is advanced to step S1008. Here let us say that the request processing unit 107 determines that the temporary registration document ID and the message to the effect that the temporary registration document has been registered is received, and the processing is advanced to step S1008.

In step S1008, the request processing unit 107 transmits the user ID of the user information received in step S1002 to the document information managing unit 105, and requests reading out of folder information which is writable by the user of the user ID. The document information managing unit 105 reads the folder information which is writable by the user of the received user ID, and transmits this to the request processing unit 107. The request processing unit 107 receives the folder information from the document information managing unit 105. Subsequently, the request processing unit 107 transmits the received folder information to the client PC 114. The processing is then advanced to step S1009.

In step S1009, the request processing unit 107 determines whether or not the folder information of the folder wherein the temporary registration document is main-registered is received from the client PC 114. In the case that the request processing 107 determines that the folder information of the folder wherein the temporary registration document is main-registered is not received from the client PC 114, the processing repeats step S1009. In the case that the request processing 107 determines that the folder information of the folder wherein the temporary registration document is main-registered is received from the client PC 114, the processing is advanced to step S1010. Here let us say that that the request processing 107 determines that the folder information of the folder wherein the temporary registration document is main-registered is received from the client PC 114, and the processing is advanced to step S1010.

In step S1010, the request processing unit 107 transmits the temporary registration document ID received in step S1007 to the temporary registration document information managing unit 106, and requests that the temporary registration document information and temporary registration document as to the temporary registration document ID is read out. The temporary registration document information managing unit 106 reads out the temporary registration document information as to the received temporary registration document ID. Also, the temporary registration document information managing unit 106 reads out the temporary registration document saved in the temporary registration document saving folder of the read temporary registration document information. The temporary registration document information managing unit 106 transmits the read out temporary registration information and temporary registration document to the request processing unit 107. The request processing unit 107 receives the temporary registration document information from the temporary registration document information managing unit 106. Also, the request processing unit 107 reads out the temporary registration document in the temporary registration document saving folder of the received temporary registration document information. The request processing unit 107 transmits the received temporary registration document information, read out temporary registration document, the user information received in step S1002, and the folder information received in step S1009, to the document information managing unit 105, and requests main registration of the document information. The document information managing unit 105 saves the received temporary registration document according to the folder information, and stores the received temporary registration document information and folder information and user information as document information. The document information managing unit 105 transmits the stored document information to the request processing unit 107. The request processing unit 107 receives document information from the document information managing unit 105. Further, the request processing unit 107 transmits the temporary registration document ID of the received temporary registration document information to the temporary registration document information managing unit 106, and requests the temporary registration document information of the temporary registration document ID to be deleted. The temporary registration document information managing unit 106 reads out the temporary registration document information of the received temporary registration document ID, deletes the document in the temporary registration document saving folder of the temporary registration document information, and deletes the temporary registration document information of the temporary registration document ID. The temporary registration document information managing unit 106 transmits a message to the effect that the temporary registration document has been deleted to the request processing unit 107. The request processing unit 107 receives the message to the effect that the temporary registration document information has been deleted from the temporary registration document information managing unit 106. The processing is then returned to step S1006.

In step S1011, the request processing unit 107 transmits the temporary registration user ID of the temporary registration user information received in step S1004 as to the temporary registration user information managing unit 104, and requests the temporary registration user information of the temporary registration user ID to be deleted. The temporary registration user information managing unit 104 deletes the temporary registration user information of the received temporary registration user ID, and transmits a message to the effect that this has been deleted to the request processing unit 107. The request processing unit 107 receives the message to the effect that the temporary registration user information has been deleted. The processing is then advanced to step S1012.

In step S1012, the request processing unit 107 transmits that no temporary registration user existed in step S1004, or the result that the request processing unit 107 deleted the temporary registration user, to the client PC 114. The processing in the flowchart shown in FIG. 11 is then ended.

### Flowchart of Client PC at Time of Obtaining Temporary Registration Document

Next, the temporary registration document obtaining processing by the client PC 114 will be described with reference to FIG. 11. FIG. 11 is a flowchart showing a sequence for temporary registration document obtaining processing by the client PC 114. This sequence is executed by an unshown CPU.

As shown in FIG. 11, with the client PC 114, first in step S1101, the overall processing unit 116 receives a temporary registration user rejection notification email 2301 shown in FIG. 23 to be described later. The temporary registration user rejection notification email 2301 is transmitted from the document managing server 101 addressed to the email address of the temporary registration user. The processing is then advanced to the step S1102.

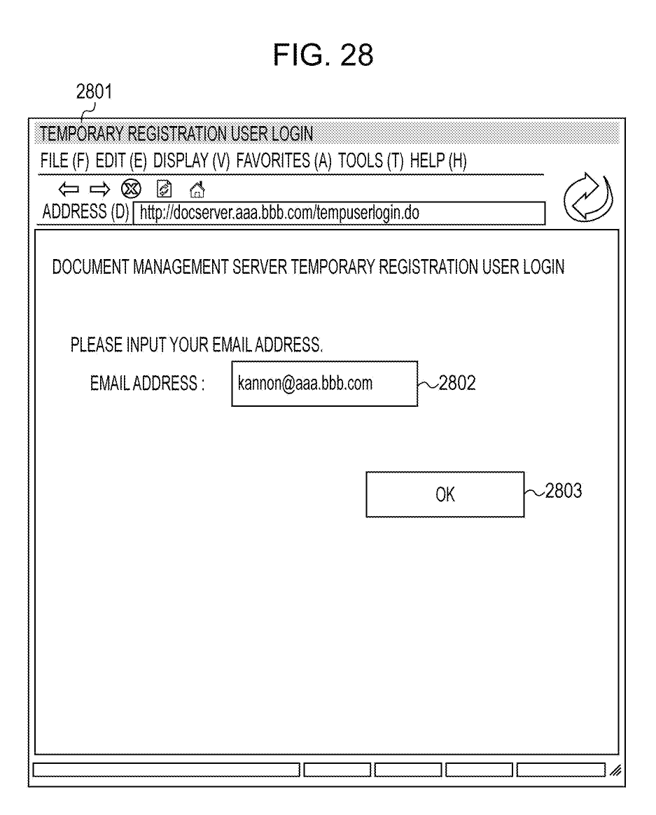

In step S1102, the overall processing unit 116 obtains a temporary user login screen URL 2306 in the temporary registration user rejection notification email 2301 shown in FIG. 23 to be described later which is received in step S1101 according to input from the temporary registration user. The overall processing unit 116 requests receipt of a temporary registration user login screen 2801, shown in FIG. 28 to be described later, to the temporary registration user login screen URL 2306. Upon receiving the temporary registration user login screen 2801 shown in FIG. 28 to be described later, the overall processing unit 116 requests the display unit 115 to display the temporary registration user login screen 2801 shown in FIG. 28 to be described later. The display unit 115 displays the temporary registration user login screen 2801 shown in FIG. 28 to be described later on an unshown CRT, according to the request thereof. Next, the temporary registration user login screen 2801 shown in FIG. 28 to be described later accepts input of an email address by a user from the email address input box 2802. Upon the temporary registration user login screen 2801 accepting the user pressing the OK button 2803, the overall processing unit 116 obtains the input email address. The processing is then advanced to step S1103.

In step S1103, the overall processing unit 116 transmits the obtained email address in step S1102 to the document managing server 101. The processing is then advanced to step S1104.

In step S1104, the overall processing unit 116 determines whether or not authentication result is received from the document managing server 101. In the case that the overall processing unit 116 determines that the authentication result is not received from the document managing server 101, the processing repeats step S1104. In the case that the overall processing unit 116 determines that the authentication result is received from the document managing server 101, the processing is advanced to step S1105. Here let us say that the overall processing unit 116 determines that the authentication result is received from the document managing server 101, and the processing is advanced to step S1105.

In step S1105, the overall processing unit 116 determines whether or not the authentication result received in step S1104 is an authentication success. In the case the overall processing unit 116 determines that the authentication result received in step S1104 is that authentication is not a success, the processing is advanced to step S1106. In the case the overall processing unit 116 determines that the authentication result received in step S1104 is that authentication is a success, the processing is advanced to step S1107. Here let us say that the overall processing unit 116 determines that the authentication result received in step S1104 is that authentication is not a success, and the processing is advanced to step S1106.

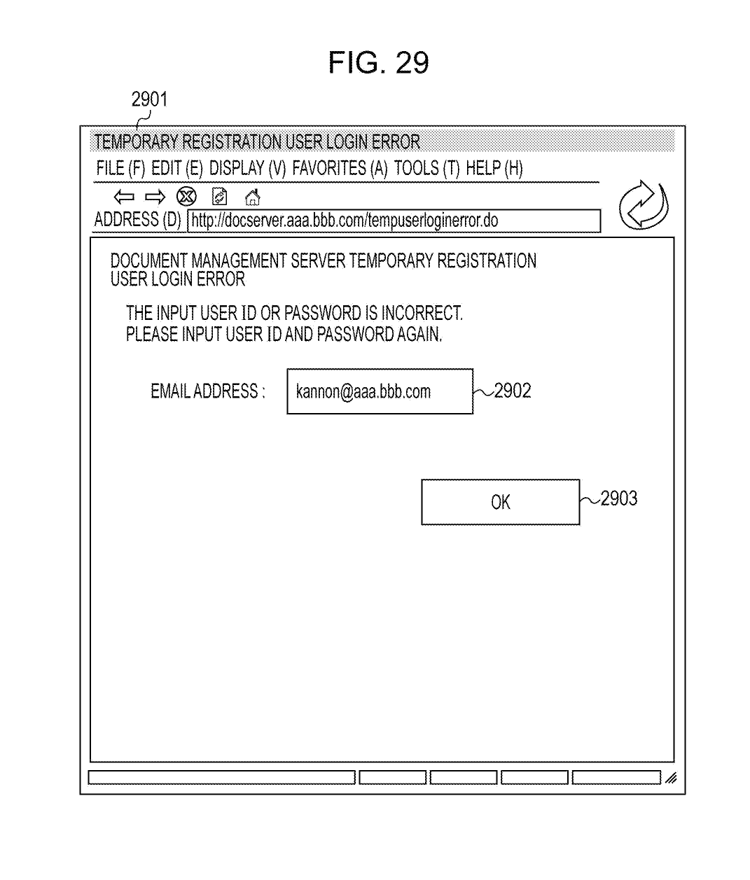

In step S1106, the overall processing unit 116 requests the display unit 115 to display a temporary registration user login error screen 2901 shown in FIG. 29 to be described later. The display unit 115 displays the temporary registration user login error screen 2901 shown in FIG. 29 to be described later on an unshown CRT, according to the request thereof. The processing is then advanced to step S1102.

In step S1107, the overall processing unit 116 determines whether or not the temporary registration document information is received from the document management server 101 in step S1104. In the case the overall processing unit 116 determines that the temporary registration document information is not received in step S1104, the processing in the flowchart shown in FIG. 11 is ended. In the case the overall processing unit 116 determines that the temporary registration document information is received in step S1104, the processing is advanced to step S1108. Here let us say that the overall processing unit 116 determines that the temporary registration document information is received in step S1104, and the processing is advanced to step S1108.

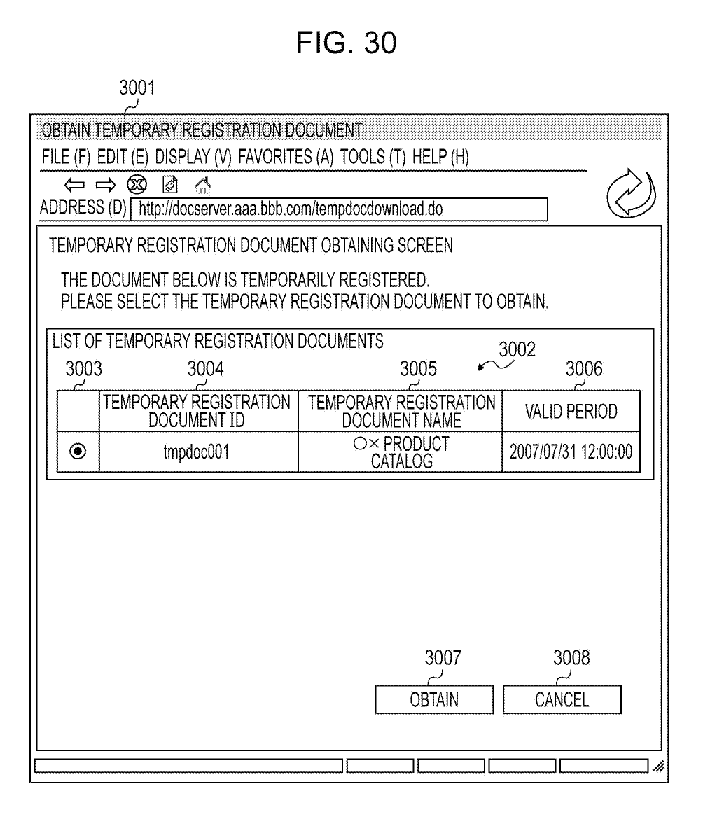

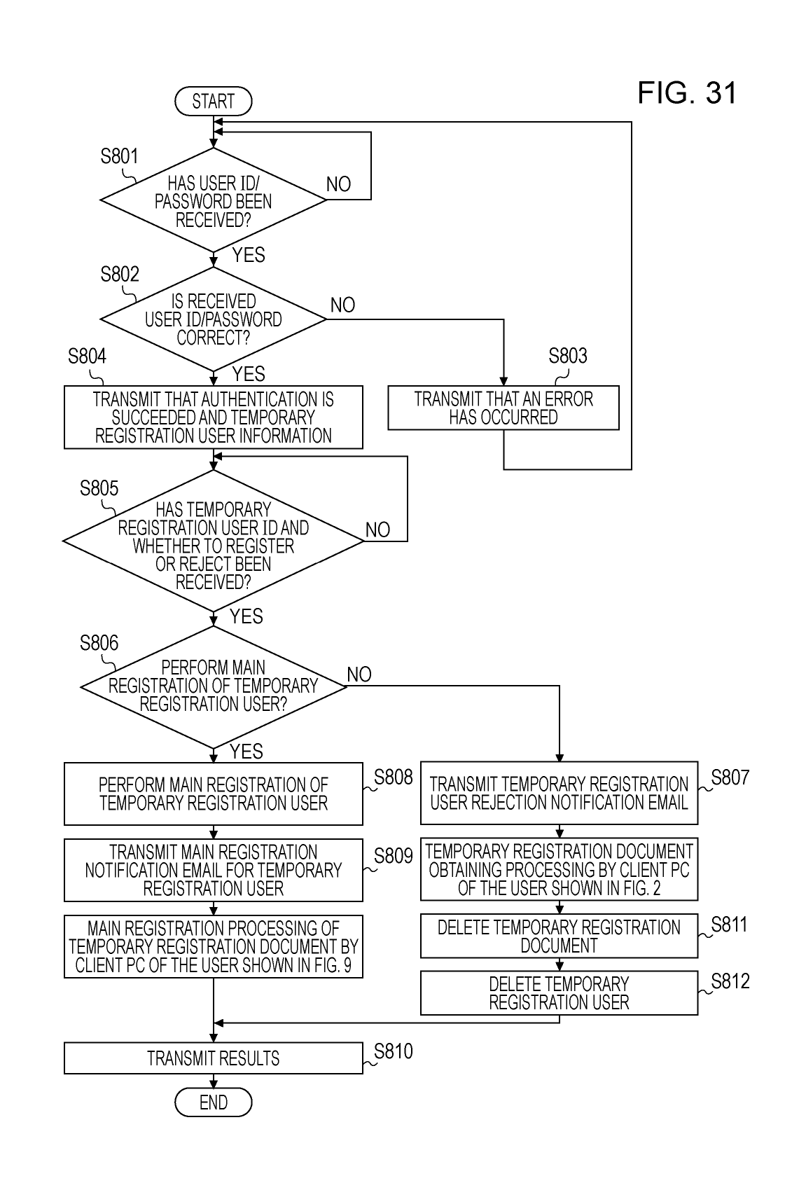

In step S1108, the overall processing unit 116 requests the display unit 115 to display a temporary registration document obtaining screen 3001 shown in FIG. 30 to be described later. The display unit 115 displays the temporary registration document obtaining screen 3001 shown in FIG. 30 to be described later on an unshown CRT in accordance with the request thereof, and accepts input of the temporary registration document by the user. In the event that an obtaining button 3007 is input by the user, the overall processing unit 116 obtains a temporary registration document ID of the temporary registration document selected with a temporary registration document selection radio button 3003 on the temporary registration document obtaining screen 3001 shown in FIG. 30 to be described later. The processing is advanced to step S1109.

In step S1109, the overall processing unit 116 transmits the temporary registration user ID obtained in step S1108, and a message to the effect that obtaining the temporary registration document is desirable, to the document managing server 101. The processing is then advanced to step S1110.

In step S1110, the overall processing unit 116 determines whether or not the temporary registration document is received from the document managing server 101. In the case the overall processing unit 116 determines that the temporary registration document is not received, the processing repeats step S1110. Note that determining that the temporary registration document is received from the document managing server 101 in step S1110 means that the overall processing unit 116 of the client PC has received the temporary registration document between steps S1109 and S1110. In the case that the overall processing unit 116 determines that the temporary registration document is received, the processing in the flowchart shown in FIG. 11 is ended. Here let us say that determination is made that the overall processing unit 116 has received the temporary registration document, and the processing is ended.

### Flowchart of Document Managing Server at Time of Temporary Registration Document Obtaining

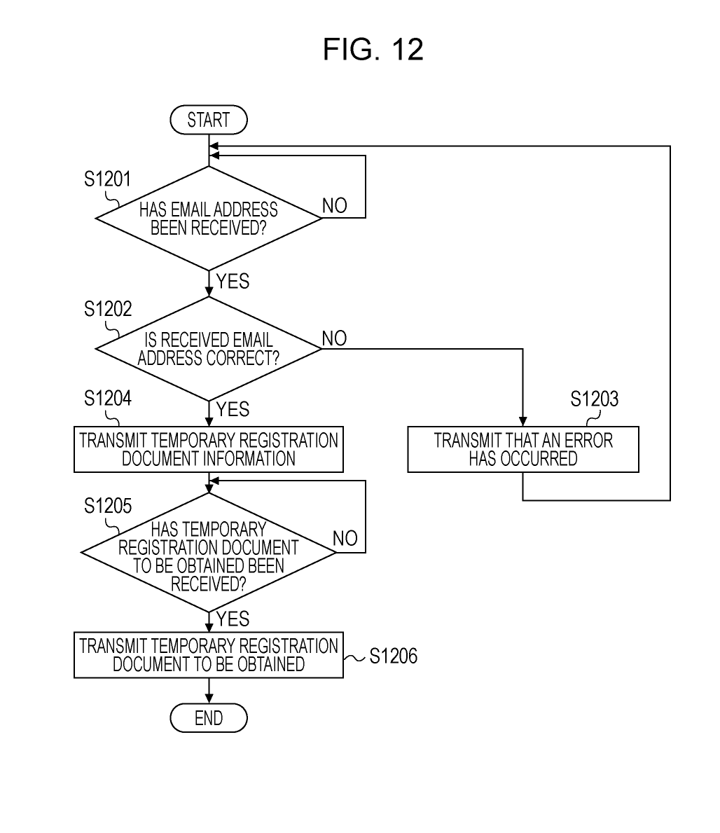

Next, the temporary registration document transmission processing by the document managing server 101 will be described with reference to FIG. 12. FIG. 12 is a flowchart showing a sequence of temporary registration document transmission processing by the document managing server 101. This sequence is executed with an unshown CPU.

With the document managing server 101, as shown in FIG. 12, first in step S1201 the request processing unit 107 determines whether or not an email address is received from the client PC 114. In the case that the request processing unit 107 determines that the email address is not received from the client PC 114, the processing repeats step S1201. In the case that the request processing unit 107 determines that the email address is received from the client PC 114, the processing is advanced to step S1202. Here let us say that the request processing unit 107 determines that the email address is received from the client PC 114, and the processing is advanced to step S1202.

In step S1202, the request processing unit 107 authenticates the email address received in step S1201. The request processing unit 107 transmits the email address received in step S1201 to the temporary registration user information managing unit 104, and requests the temporary registration user information corresponding to the email address to be read out. The temporary registration user information managing unit 104 reads out the temporary registration user information as to the received email address, and transmits this to the request processing unit 107. In the case that the request processing unit 107 determines that temporary registration user information is received from the temporary registration user information managing unit 104 as the authentication having succeeded, the processing is advanced to step S1204. In the case that the request processing unit 107 determines that temporary registration user information is not received from the temporary registration user information managing unit 104 as the authentication having failed, the processing is advanced to step S1203. Here let us say that the request processing unit 107 determines that temporary registration user information is not received from the temporary registration user information managing unit 104 as the authentication having failed, and the processing is advanced to step S1203.

In step S1203, the request processing unit 107 transmits a message to the effect that an authentication error has occurred to the client PC 114. The processing is then returned to step S1201.

In step S1204, the request processing unit 107 transmits the temporary registration user ID of the temporary registration user information received in step S1202 to the temporary registration document information managing unit 106, and requests the temporary registration document information associated with the temporary registration user ID to be read out. The temporary registration document information managing unit 106 reads out the temporary registration document information associated to the received temporary registration user ID, and transmits this to the request processing unit 107. Subsequently, the request processing unit 107 receives temporary registration document information from the temporary registration user information managing unit 104. Further, the request processing unit 107 transmits the received temporary registration document information to the client PC 114. The processing is then advanced to step S1205.

In step S1205, the request processing unit 107 determines whether or not the temporary registration document ID of the temporary registration document which the temporary registration user obtains is received from the client PC 114. In the case that the request processing unit 107 determines that the temporary registration document ID of the temporary registration document which the temporary registration user obtains is not received from the client PC 114, the processing repeats step S1205. In the case that the request processing unit 107 determines that the temporary registration document ID of the temporary registration document which the temporary registration user obtains is received from the client PC 114, the processing is advanced to step S1206. Here let us say that the request processing unit 107 determines that the temporary registration document ID of the temporary registration document which the temporary registration user obtains is received from the client PC 114, and the processing is advanced to step S1206.

In step S1206, the request processing unit 107 transmits the temporary registration document ID received in step S1205 to the temporary registration document information managing unit 106, and requests obtaining of the temporary registration document of the temporary registration document ID. The temporary registration document information managing unit 106 reads out the temporary registration document information of the received temporary registration document ID, reads out the temporary registration document from the temporary registration document saving folder of the read out temporary registration document information, and transmits this to the request processing unit 107. The request processing unit 107 transmits the temporary registration document received from the temporary registration document information managing unit 106 to the client PC 114. The processing of the flowchart shown in FIG. 12 is then ended.

### Device Login Screen

Next, a device login screen 1301 will be described with reference to FIG. 13. FIG. 13 is an example of a device login screen displayed on the image forming device 109. The display processing of this screen is executed with the display unit 112. A touch panel on a liquid crystal display device 312 is employed for input operation by a user on the present screen.

A user ID input box 1302, password input box 1303, and OK button 1304 are displayed on the device login screen 1301. Also, a user group input box or a user affiliation input box and the like can be added to the device login screen 1301 as user information, for example.

The user ID input box 1302 is an input box for accepting input of the device user ID in the device user information from the user as to the image forming device 109. The input device user ID is employed for user authentication with the overall processing unit 113.

The password input box 1303 is an input box for accepting input of the device user password in the device user information from the user to the image forming device 109. The input device user password is employed for user authentication with the overall processing unit 113.

The OK button 1304 is a button for accepting instructions performing device user authentication employing a device user ID and device user password from the user to the image forming device 109. Upon the OK button 1304 being pressed, the device user ID input in the user ID input box 1302 and the device user password input in the password input box 1303 are obtained with the overall processing unit 113 as device user information. In the case that the user authentication result determined by the overall processing unit 113 is that the authentication is a failure, a display is shown on the device login screen 1301 to the effect that the authentication is a failure. Also, in the case that the user authentication result determined by the overall processing unit 113 is that the authentication is a success, the process is transitioned to a device processing screen 1401 shown in FIG. 14 to be described later.

### Device Processing Screen

Next, the device processing screen 1401 will be described with reference to FIG. 14. FIG. 14 is an example of a device processing screen displayed on the image forming device 109. The screen display processing is executed with the display unit 112. A touch panel on a liquid crystal display device 312 is employed for input operation by a user on the present screen.

A size ratio display 1402, sheet display 1403, number of copies display 1404, size ratio button 1405, sheet button 1406, darkness button 1407, image quality button 1408, finishing button 1409, duplex button 1410 are displayed on the device processing screen 1401. Further, a print button 1411, transmit button 1412, and BOX button 1413 are displayed on the device processing screen 1401. Note that for example an original document state display, shortcut executing button, help button and so forth can be added to the device processing screen 1401.

The size ratio display 1402 displays the size ratio set in the event that the user presses the size ratio button 1405 to be described later. The sheet display 1403 displays the sheet information set in the event that the user presses the sheet button 1406 to be described later. The sheet display 1403 is provided on the device processing screen 1401 according to the present embodiment, but the sheet display 1403 is not necessary. The number of copies display 1404 displays the number of copies set in the event that the user presses the sheet button 1406 to be described later. The number of copies display 1404 is provided on the device processing screen 1401 according to the present embodiment, but the number of copies display 1404 is not necessary.

The size ratio button 1405 is a button for the user to set size ratio at the time of scanning or at the time of printing, as a device processing setting. The sheet button 1406 is a button for the user to set the sheet and number of copies at the time of printing, as a device processing setting. The sheet button 1406 is provided on the device processing screen 1401 according to the present embodiment, but the sheet button 1406 is not necessary.

The darkness button 1407 is a button for the user to set the darkness at the time of scanning as a device processing setting. The image quality button 1408 is a button for the user to set the image quality at the time of scanning as a device processing setting. The finishing button 1409 is a button for the user to set the finishing at the time of printing as a device processing setting. The finishing button 1409 is provided on the device processing screen 1401 according to the present embodiment, but the finishing button 1409 is not necessary. The duplex button 1410 is a button for the user to set duplex settings at the time of scanning or at the time of printing, as a device processing setting.

The print button 1411 is a button for the user to set printing settings to instruct printing, as a device processing setting. The print button 1411 is provided on the device processing screen 1401, but the print button 1411 is not necessary. The transmit button 1412 is a button for the user to set transmission settings and instruct transmission as a device processing setting. The BOX button 1413 is a button for the user to set BOX operation settings and to instruct BOX operations as a device processing setting. The BOX button 1413 is provided on the device processing screen 1401 according to the present embodiment, but the BOX button 1413 is not necessary.

### Transmission Destination Selection Screen

Next, a transmission destination selection screen 1501 will be described with reference to FIG. 15. FIG. 15 is an example of a transmission destination selection screen displayed on the image forming device 109. This screen display processing is executed with the display unit 112. A touch panel on a liquid crystal display device 312 is employed for input operation by a user on the present screen.

Transmission destination selection radio buttons 1502, transmission destination ID display 1503, transmission destination display 1504, and transmission destination address display 1505 are displayed on the transmission destination selection screen 1501. Also, a transmission destination user ID input box 1506, transmission destination password input box 1507, document saving folder input box 1508, OK button 1509, and cancel button 1510 are displayed on the transmission destination selection screen 1501. Note that of the transmission destination selection radio buttons 1502, only one can be selected. Also, for example a transmission destination type display, protocol display, property button, help button, and so forth can be added to the transmission destination selection screen 1501.

The transmission destination selection radio button 1502 is a button which is pressed in the event of accepting a selection of a transmission destination to transmit a document by the user. In the case that the transmission destination selection radio button 1502 is pressed, the transmission destination to which the user desires to transmit the document can be selected.

The transmission destination ID display 1503 is a display of the transmission destination ID of a transmission destination to which the document can be transmitted.

The transmission destination name display 1504 is a display of the transmission destination name of the transmission destination to which the document can be transmitted. The transmission destination name display 1504 is provided on the transmission destination selection screen 1501 according to the present embodiment, but the transmission destination name display 1504 is not necessary.

The transmission destination address display 1505 is a display of a transmission destination address to which the document can be transmitted. The transmission destination address display 1505 is provided on the transmission destination selection screen 1501 according to the present embodiment, but the transmission destination address display 1501 is not necessary.

The transmission destination user ID input box 1506 is an input box for accepting input of the user ID in the user information from the user as to the image forming device 109. The input user ID is transmitted from the overall processing unit 113 to the document managing server 101, and is employed for user authentication.

The transmission destination password ID input box 1507 is an input box for accepting input of the user password in the user information from the user as to the image forming device 109. The input password is transmitted from the overall processing unit 113 to the document managing server 101, and is employed for user authentication.

The document saving folding input box 1508 is an input box for accepting input of a folder wherein a document is saved on the document managing server 101 from the user as to the image forming device 109. The input document saving folder is transmitted from the overall processing unit 113 to the document managing server 101, and is employed for main registration of the document.

The OK button 1509 is a button for accepting instructions to transmit a document to the transmission destination address in the transmission destination information selected with the transmission destination selection screen 1501 from the user as to the image forming device 109. Upon the OK button 1509 being pressed, the overall processing unit 113 obtains the transmission destination ID in the transmission destination information selected with the transmission destination selection radio button 1502 on the transmission destination selection screen 1501 selected by the user. Also, the overall processing unit 113 obtains the transmission destination user ID input by the user in the transmission destination user ID input box and the transmission destination password input by the user in the transmission destination password input box. Further, the overall processing unit 113 obtains the document saving folder input by the user in the document saving folder input box 1508.

The cancel button 1510 is a button for receiving instructions to stop the processing without executing transmission of the document from the user as to the image forming device 109. Upon the cancel button 1510 being pressed, the image forming device 109 stops the processing, and requests the overall processing unit 116 to display the device processing screen 1401.

### Transmission Result Screen

Next, a transmission result screen 1601 will be described with reference to FIG. 16. FIG. 16 is an example of a transmission result screen displayed on the image forming device 109. The display processing of this screen is executed with the display unit 112. A touch panel on a liquid crystal display device 312 is employed for input operation by a user on the present screen.

A transmission destination ID display 1602, transmission destination name display 1603, transmission destination address display 1604, and transmission result display 1605 are displayed on the transmission result screen 1601. Also, for example a transmission point-in-time display, property button, help button and the like can be added to the transmission result screen 1601.

The transmission destination ID display 1602 is a display of the transmission destination ID of the transmission destination to which the overall processing unit 113 transmits the document. The transmission destination ID display 1602 is provided on the transmission destination result screen 1601 according to the present embodiment, but the transmission destination ID display 1602 is not necessary.

The transmission destination name display 1603 is a display of the transmission name of the transmission destination to which the overall processing unit 113 transmits the document. The transmission destination name display 1603 is provided on the transmission result screen 1601 according to the present embodiment, but the transmission destination name display 1603 is not necessary.

The transmission destination address display 1604 is a display of an address of the transmission destination to which the overall processing unit 113 transmits the document. The transmission destination address display 1604 is provided on the transmission result screen 1601 according to the present embodiment, but the transmission destination address display 1604 is not necessary.

The transmission result display 1605 is a display of the transmission result received from the document managing server 101 wherein the overall processing unit 113 transmits the document.

The OK button 1606 is a button for accepting input from the user as to the image forming device 109, to confirm the transmission result with the transmission result screen 1601 and transitions to the device processing screen 1401. Upon the OK button 1606 being pressed, the overall processing unit 113 returns to the device processing screen 1401, as the user has confirmed the transmission result.

### Diagram to Show Temporary Registration User Main Registration/Rejection Request Email

Next, a temporary registration user main registration/rejection request email 1701 will be described with reference to FIG. 17. The temporary registration user main registration/rejection request email 1701 has a date header 1702, sender email address header 1703, addressee email address header 1704, title header 1705, and URL 1706, as shown in FIG. 17. The URL 1706 is a manager login screen URL. Also, the temporary registration user main registration/rejection request email 1701 has a temporary registration user ID 1707, temporary registration user name 1708, and temporary registration user email address 1709. Also, for example a temporary registration document ID of the temporary registration document, temporary registration document name, and temporary registration document saving folder can be added to the temporary registration user main registration/rejection request email 1701. With the temporary registration user main registration/rejection request email 1701, the document managing server 101 ends the user temporary registration and document temporary registration corresponding to the user temporary registration and document temporary registration request instructed by the user from the image forming device 109. The temporary registration user main registration/rejection request email 1701 is a temporary registration user main registration/rejection request email wherein subsequently, the document managing server 101 requests main registration/rejection of the temporary registration user to the manager.

The date header 1702 has the date set wherein the temporary registration user main registration/rejection request email 1701 is transmitted from the document managing server 101.

The sender email address header 1703 has set the email address of the sending user of the temporary registration user main registration/rejection request email 1701, i.e. the email address of the document managing server 101.

The addressee email address header 1704 has set the email address of the address destination user of the temporary registration user main registration/rejection request email 1701, i.e. the values of the email address of the manager of the document managing server 101.

The title header 1705 has set the title of the temporary registration user main registration/rejection request email 1701, i.e. a title to the effect that the email is a temporary registration user main registration/rejection request email.

The URL 1706 has set the URL of a manager login screen 1801 shown in FIG. 18 to be described later in the event of the manager logging in to the document managing server. Note that the manager login screen URL 1706 is provided on the temporary registration user main registration/rejection request email 1701 according to the present embodiment. However, instead of the manager login screen URL 1706, a temporary registration user main registration screen 2001 URL shown in FIG. 20 to be described later may be set therein.

The temporary registration user ID 1707 has a temporary registration user ID set for a user temporarily registered with the document managing server 101. The temporary registration user ID 1707 is provided on the temporary registration user main registration/rejection request email 1701 according to the present embodiment, but the temporary registration user ID 1707 is not necessary.

The temporary registration user name 1708 has a temporary registration user name set for a user temporarily registered with the document managing server 101. The temporary registration user name 1708 is provided on the temporary registration user main registration/rejection request email 1701 according to the present embodiment, but the temporary registration user name 1708 is not necessary.

The temporary registration user email address 1709 has a temporary registration user email address of a temporarily registered user on the document managing server 101. The temporary registration user email address 1709 is provided on the temporary registration user main registration/rejection request email 1701 according to the present embodiment, but the temporary registration user email address 1709 is not necessary.

### Manager Login Screen

Next, a manager login screen 1801 will be described with reference to FIG. 18. FIG. 18 is an example of the manager login screen displayed on the client PC 114. The display processing of this screen is executed with the display unit 115. A keyboard or mouse is used for input operation by the user on the present screen.

A user ID input box 1802, password input box 1803, and OK button 1804 are displayed on the manager login screen 1801. Also, for example a user group input box or a user affiliation input box can be added to the manager login screen 1801 as user information.

The user ID input box 1802 is an input box for the client PC 114 to accept the input of the user ID in the user information from the manager. The input user ID is transmitted by overall processing unit 116 to the document managing server 101, and is employed for user authentication with the document managing server 101.

The password input box 1803 is an input box for the client PC 114 to accept input of a password in the user information from the manager. The input password is transmitted by the overall processing unit 116 to the document managing server 101, and is employed for user authentication with the document managing server 101.

The OK button 1804 is a button for the client PC 114 to accept instructions for transmitting a user ID and password to the document managing server 101 and performing user authentication. Upon the OK button 1804 being pressed, the overall processing unit 116 transmits the user ID input in the user ID input box 1802 and the password input in the password input box 1803 to the document managing server 101. Upon the user authentication processing ending with the document managing server 101, the overall processing unit 116 receives the user authentication result thereof. In the case that the user authentication result received by the overall processing unit 116 is that authentication has failed, the overall processing unit 116 requests the display unit 115 to display a manager login error screen 1901 shown in FIG. 19 to be described later. In the case that the user authentication result received by the overall processing unit 116 is that the authentication has succeeded, the overall processing unit 116 requests the display unit 115 to display a temporary registration user main registration screen 2001 shown in FIG. 20 to be described later.

### Manager Login Error Screen

Next, the manager login error screen 1901 will be described with reference to FIG. 19. FIG. 19 is an example of a manager login error screen displayed on the client PC 114. The display processing of this screen is executed with the display unit 115 based on a command from an unshown CPU. A keyboard or mouse is used for input operation by the user on the present screen.

A user ID input box 1902, password input box 1903, and OK button 1904 are displayed on the manager login error screen 1901. Also, for example a user group input box or user affiliation input box can be added to the manager login error screen 1901 as user information.

The user ID input box 1902 is an input box for the client PC 114 to accept input again of the user ID in the user information from the manager. The re-input user ID is transmitted by the overall processing unit 116 to the document managing server 101, and is used for user authentication with the document managing server 101.

The password input box 1903 is an input box for the client PC 114 to accept re-input of the password in the user information from the manager. The re-input password is transmitted by the overall processing unit 116 to the document managing server 101, and is used for user authentication with the document managing server 101.

The OK button 1904 is a button for the client PC 114 to transmit the user ID and password to the document managing server 101 from the manager, and to accept instructions to perform user authentication again. Upon the OK button 1904 being pressed, the overall processing unit 116 transmits the user ID input in the user ID input box 1902 and the password input in the password input box 1903 to the document managing server 101. Upon the user authentication processing with the document managing server 101 ending, the overall processing unit 116 receives the user authentication result. In the case that the user authentication result received by the overall processing unit 116 is that authentication has failed, the overall processing unit 116 requests the display unit 115 to display the manager login error screen 1901 again. In the case that the user authentication result received by the overall processing unit 116 is that authentication has succeeded, the overall processing unit 116 requests the display unit 115 to display the temporary registration user main registration screen 2001.

### Temporary Registration User Main Registration Screen

Next, the temporary registration user main registration screen 2001 will be described with reference to FIG. 20. FIG. 20 is an example of the temporary registration user main registration screen displayed on the client PC 114. The display processing of this screen is executed with the display unit 115 based on a command from an unshown CPU. A keyboard or mouse is used for input operation by the user on the present screen.

A temporary registration user list display 2002, temporary registration user selection radio button 2003, temporary registration user ID 2004, temporary registration user name 2005, and temporary registration user email address 2006 are displayed on the temporary registration user main registration screen 2001. Also, a main registration button 2007, reject button 2008, and cancel button 2009 are displayed on the temporary registration user main registration screen 2001. Also, for example a number of temporary registration documents, property button, and help button can be added to the temporary registration user main registration screen 2001.

The temporary registration user list display 2002 is a list display of a temporary registration user which the manager can main-register.

The temporary registration user selection radio button 2003 is a button to accept selection input from the temporary registration user to be main-registered by the manager. In the case that the temporary registration user selection radio button 2003 is pressed, the manager can select the temporary registration user to main register.

The temporary registration user ID 2004 is a display of the temporary registration user ID of the temporarily registered user.

The temporary registration user name 2005 is a display of the temporary registration user name of the temporarily registered user. With the present embodiment, the temporary registration user name 2005 is provided on the temporary registration user main registration screen 2001, but the temporary registration user name 2005 is not necessary.

The temporary registration user email address 2006 is a display of the temporary registration user email address of the temporarily registered user. With the present embodiment, the temporary registration user email address 2006 is provided on the temporary registration user main registration screen 2001, but the temporary registration user email address 2006 is not necessary.

The main registration button 2007 is a button for the client PC 114 to transmit the temporary registration user ID to the document managing server 101 and to accept instruction from the manager for performing main registration of the temporary registration user. Upon the main registration button 2007 being pressed, the overall processing unit 116 transmits the temporary registration user ID of the temporary registration user information selectively input in the temporary registration user selection radio button 2003 to the document managing server 101. Upon the temporary registration user main registration processing with the document managing server 101 ending, the overall processing unit 116 receives the temporary registration user main registration result. The overall processing unit 116 requests the display unit 115 to display the screen 2101 of the temporary registration user main registration result shown in FIG. 21 to be described later.

The reject button 2008 is a button for the client PC 114 to transmit the temporary registration user ID to the document managing server 101 and to accept instruction from the manager for performing rejection of the temporary registration user. Upon the reject button 2008 being pressed, the overall processing unit 116 transmits the temporary registration user ID of the temporary registration user information selectively input in the temporary registration user selection radio button 2003 to the document managing server 101. Upon the temporary registration user rejection processing with the document managing server 101 ending, the overall processing unit 116 receives the temporary registration user rejection result. The overall processing unit 116 requests the display unit 115 to display the screen 2101 of the temporary registration user rejection result shown in FIG. 21 to be described later.

The cancel button 2009 is a button for the client PC 114 to cancel the temporary registration user main registration by the manager, and to transition to the manager login screen 1801. Upon the cancel button 2009 screen being pressed, the overall processing unit 116 requests the display unit 115 to display the manager login screen 1801.

### Temporary Registration User Main Registration Result Screen

Next, a temporary registration user main registration result screen 2101 will be described with reference to FIG. 21. FIG. 21 is an example of the temporary registration user main registration result screen displayed on the client PC 114. The display processing of this screen is executed with the display unit 115 based on a command from an unshown CPU. A keyboard or mouse is used for input operation by the user on the present screen.

On the temporary registration user main registration result screen 2101 shown in FIG. 21, that which is indicated with reference numerals 2102 through 2110 are displayed. Reference numeral 2102 denotes a temporary registration user information display. Also, reference numeral 2103 denotes a temporary registration user ID display. Also, reference numeral 2104 denotes a temporary registration user name display. Also, reference numeral 2105 denotes a temporary registration user email address. Also, reference numeral 2106 denotes a main registration user information display. Also, reference numeral 2107 denotes registration user ID display. Also, reference numeral 2108 denotes a registration user name display. Also, reference numeral 2109 denotes a registration user email address display. Also, reference numeral 2110 denotes an OK button. Also, for example a number of temporary registration documents, property button, and help button can be added to the temporary registration user main registration result screen 2101.

The temporary registration user information display 2102 is a display for temporary registration user information of a temporarily registered user. The temporary registration user ID display 2103 is a display of the temporary registration user ID of a temporarily registered user. The temporary registration user name display 2104 is a display of the temporary registration user name of a temporarily registered user.

With the present embodiment, the temporary registration user name display 2104 is provided on the temporary registration user main registration result screen 2101, but the temporary registration user name display 2104 is not necessary.

The temporary registration user email address display 2105 is a display of the temporary registration user email address of the temporarily registered user. With the present embodiment, the temporary registration user email address 2104 is provided on the temporary registration user main registration result screen 2101, but the temporary registration user email address display 2105 is not necessary.

The main registration user information display 2106 is a display of user information of a newly main-registered user. The main registration user ID display 2107 is a display of a user ID of a newly main-registered user. The main registration user name display 2108 is a display of a user name of a newly main-registered user. With the present embodiment, the main registration user name display 2108 is provided on the temporary registration user main registration result screen 2101, but the main registration user name display 2108 is not needed.

The main registration user email address display 2109 is a display of user email address of a newly main-registered user. With the present embodiment, the main registration user email address 2109 is provided on the temporary registration user main registration result screen 2101, but the main registration user email address 2109 is not needed.

The OK button 2110 is a button on the temporary registration user main registration result screen 2101 for the client PC 114 to accept input from the user to the effect that the temporary registration user main registration result is confirmed and processing is ended. Upon the OK button 2110 being pressed, the overall processing unit 116 ends the processing, with the user having confirmed the temporary registration user main registration result.

### Diagram to Show Temporary Registration User Main Registration Notification Email

Next, a temporary registration user main registration notification email 2201 will be described with reference to FIG. 22. The temporary registration user main registration notification email 2201 has a date header 2202, sender email address header 2203, addressee email address header 2204, title header 2205, and URL 2206, as shown in FIG. 22. Also, the temporary registration user main registration notification email 2201 has a main registration user ID 2207, main registration user name 2208, main registration user email address 2209. Also, a temporary registration document ID and temporary registration document name of the temporary registration document, manager user ID, and manager user name for example can be added to the temporary registration user main registration notification email 2201. The temporary registration user main registration notification email 2201 is for the document managing server 101 to notify temporary registration to the user in the case that the client PC 114 requests temporary registration user main registration to the document managing server 101 by input from the manager.

The date header 2202 has the date set wherein the temporary registration user main registration notification email 2201 is transmitted from the document managing server 101.

The sender email address header 2203 has set the email address of the sending user of the temporary registration user main registration notification email 2201, i.e. the email address of the document managing server 101.

The addressee email address header 2204 has set the email address of the address destination user of the temporary registration user main registration notification email 2201, i.e. the values of the email address of the manager of the document managing server 101.

The title header 2205 has set the title of the temporary registration user main registration notification email 2201, i.e. a title to the effect that the email is a temporary registration user main registration notification email.

The URL 2206 has set the URL of a user login screen 2401 shown in FIG. 24 to be described later in the event of the user logging in to the document managing server. Note that the user login screen URL 2206 is provided on the temporary registration user main registration notification email 2201 according to the present embodiment. However, instead of the user login screen URL 2206, a URL of the temporary registration document main registration screen 2601 shown in FIG. 26 to be described later may be set therein.

The main registration user ID 2207 has a user ID set for a user main-registered with the document managing server 101. With the present embodiment, the main registration user ID 2207 is provided on the temporary registration user main registration notification email 2201, but the main registration user ID 2207 is not necessary.

The main registration user name 2208 has a user name set for a user main-registered with the document managing server 101. With the present embodiment, the main registration user name 2208 is provided on the temporary registration user main registration notification email 2201, but the main registration user name 2208 is not necessary.

The main registration user email address 2209 has user email address set for a user main-registered with the document managing server 101. With the present embodiment, the main registration user email address 2209 is provided on the temporary registration user main registration notification email 2201, but the main registration user email address 2209 is not necessary.

### Diagram to Show Temporary Registration User Rejection Notification Email

Next, a temporary registration user rejection notification email 2301 will be described with reference to FIG. 23. The temporary registration user rejection notification email 2301 has a date header 2302, sender email address header 2303, addressee email address header 2304, title header 2305, and temporary registration user login screen URL 2306, as shown in FIG. 23. Also, temporary registration user rejection notification email 2301 has a temporary registration user ID 2307, temporary registration user ID 2308, and temporary registration user email address 2309. Also, for example a temporary registration document ID and temporary registration document name of the temporary registration document, manager user ID, and manger user name can be added to the temporary registration user rejection notification email 2301. The temporary registration user rejection notification email 2301 is for the document managing server 101 to notify the user of rejection of the temporary registration user, in the case that the client PC 114 has requested rejection of a temporary registration user to the document managing server 101 by input from a manager.

The date header 2302 has the date set wherein the temporary registration user rejection notification email 2301 is transmitted from the document managing server 101. The sender email address header 2303 has set the email address of the sending user of the temporary registration user rejection notification email 2301, i.e. the email address of the document managing server 101. The addressee email address header 2304 has set the email address of the address destination user of the temporary registration user rejection notification email 2301, i.e. the values of the email address of the manager of the document managing server 101. The title header 2305 has set the title of the temporary registration user rejection notification email 2301, i.e. a title to the effect that the email is a temporary registration user main rejection notification email.

The URL 2306 of the temporary registration user login screen has a URL set for the temporary registration user login screen 2801 shown in FIG. 28 to be described later in the event that the temporary registration user logs in to the document managing server. Note that with the present embodiment, the temporary registration user login screen URL 2306 is provided on the temporary registration user rejection notification email 2301. However, instead of the temporary registration user login screen URL 2306, a URL for a temporary registration document obtaining screen 3001 shown in FIG. 30 to be described later can be set.

The temporary registration user ID 2307 has a temporary registration user ID of the user temporarily registered with the document managing server 101. The temporary registration user ID 2307 is provided on the temporary registration user rejection notification email 2301 according to the present embodiment, but the temporary registration user ID 2307 is not necessary.

The temporary registration user ID 2308 has a temporary registration user name of the user temporarily registered with the document managing server 101. The temporary registration user name 2308 is provided on the temporary registration user rejection notification email 2301 according to the present embodiment, but the temporary registration user name 2308 is not necessary.

The temporary registration user email address 2309 has a temporary registration user email address of the user temporarily registered with the document managing server 101. The temporary registration user email address 2309 is provided on the temporary registration user rejection notification email 2301 according to the present embodiment, but the temporary registration user email address 2309 is not necessary.

### User Login Screen

Next, a user login screen 2401 will be described with reference to FIG. 24. FIG. 24 is an example of a user login screen displayed on the client PC 114. The display processing of this screen is executed with the display unit 115 based on a command from an unshown CPU. A keyboard or mouse is used for input operation by the user on the present screen.

The user login screen 2401 has a user ID input box 2402, password input box 2403, and OK button 2404. Also, for example a user group input box or user affiliation input box can be added to the user login screen 2401 as user information.

The user ID input box 2402 is an input box for the client PC 114 to accept input of a user ID in the user information from the user. The input user ID is transmitted by the overall processing unit 116 to the document managing server 101, and is employed for user authentication with the document managing server 101.

The password input box 2403 is an input box for the client PC 114 to accept input of a password in the user information from the user. The input password is transmitted by the overall processing unit 116 to the document managing server 101, and is employed for user authentication with the document managing server 101.

The OK button 2404 is a button for the client PC 114 to accept instructions from the user for transmitting a user ID and password to the document managing server 101 and performing user authentication. Upon the OK button 2404 being pressed, the overall processing unit 116 transmits the user ID input in the user ID input box 2402 and the password input in the password input box 2403 to the document managing server 101. Upon the user authentication processing ending with the document managing server 101, the overall processing unit 116 receives the user authentication result thereof. In the case that the user authentication result received by the overall processing unit 116 is that authentication has failed, the overall processing unit 116 requests the display unit 115 to display a user login error screen 2501 shown in FIG. 25 to be described later. In the case that the user authentication result received by the overall processing unit 116 is that the authentication has succeeded, the overall processing unit 116 requests the display unit 115 to display a temporary registration document main registration screen 2601 shown in FIG. 26 to be described later.

### User Login Error Screen

Next, a user login error screen 2501 will be described with reference to FIG. 25. FIG. 25 is an example of a user login error screen displayed on the client PC 114. The display processing of this screen is executed with the display unit 115 based on a command from an unshown CPU. A keyboard or mouse is used for input operation by the user on the present screen.

A user ID input box 2502, password input box 2503, and OK button 2504 are displayed on the user login error screen 2501. Also, for example a user group input box or user affiliation input box can be added to the user login error screen 2501 as user information.

The user ID input box 2502 is an input box for the client PC 114 to accept re-input of the user ID in the user information from the user. The re-input user ID is transmitted to the document managing server 101 by the overall processing unit 116, and is employed for user authentication with the document managing server 101.

The password input box 2503 is an input box for the client PC 114 to accept re-input of the password in the user information from the user. The re-input password is transmitted to the document managing server 101 by the overall processing unit 116, and is employed for user authentication with the document managing server 101.

The OK button 2504 is a button for the client PC 114 to accept instructions from the user for transmitting a user ID and password to the document managing server 101 and performing user authentication. Upon the OK button 2504 being pressed, the overall processing unit 116 transmits the user ID input in the user ID input box 2502 and the password input in the password input box 2503 to the document managing server 101. Upon the user authentication processing ending with the document managing server 101, the overall processing unit 116 receives the user authentication result thereof. In the case that the user authentication result received by the overall processing unit 116 is that authentication has failed, the overall processing unit 116 requests the display unit 115 to display the user login error screen 2501 again. In the case that the user authentication result received by the overall processing unit 116 is that the authentication has succeeded, the overall processing unit 116 requests the display unit 115 to display a temporary registration document main registration screen 2601 shown in FIG. 26 to be described later.

### Temporary Registration Document Main Registration Screen

Next, the temporary registration document main registration screen 2601 will be described with reference to FIG. 26. FIG. 26 is an example of the temporary registration document main registration screen displayed on the client PC 114. The display processing of this screen is executed with the display unit 115 based on a command from an unshown CPU. A keyboard or mouse is used for input operation by the user on the present screen.

A temporary registration document list display 2602, temporary registration document selection radio button 2603, temporary registration document ID 2604, temporary registration document name 2605, main registration button 2606, and cancel button 2607 are displayed on the temporary registration document main registration screen 2601. Also, for example a temporary registration user ID, temporary registration user name, temporary registration user email address, file size, property button, and help button can be added to the temporary registration document main registration screen 2601.

The temporary registration document list display 2602 is a list display of temporary registration documents that the user can main-register.

The temporary registration document selection radio button 2603 is a button for accepting selection input from the user for a temporary registration document that that is main-registered. In the case that the temporary registration document selection radio button 2603 is pressed, the user can select the temporary registration document that the user desires to register.

The temporary registration document ID 2604 is a display of a temporary registration document ID of a temporarily registered document.

The temporary registration document name 2605 is a display of a temporary registration document name of a temporarily registered document. The temporary registration document name 2605 is provided on the temporary registration document main registration screen 2601 according to the present embodiment, but the temporary registration document name 2605 is not necessary.

The main registration button 2606 is a button for the client PC 114 to accept instructions from the user to transmit the temporary registration document ID to the document managing server 101 and to perform main registration of the temporary registration document. Upon the main registration button 2606 being pressed, the overall processing unit 116 transmits the temporary registration document ID of the temporary registration document information that is selectively input in the temporary registration document selection radio button 2603 to the document managing server 101. Subsequently, the overall processing unit 116 receives folder information which is accessible by the user from the document managing server 101. The overall processing unit 116 then requests the display unit 115 to display a temporary registration document main registration folder selection screen 2701 shown in FIG. 27 to be described later.

The cancel button 2607 is a button for the client PC 114 to cancel the main registration of the temporary registration document by the user, and to transition to the user login screen 2401. Upon the cancel button 2607 screen being pressed, the overall processing unit 116 requests the display unit 115 to display the user login screen 2401.

### Temporary Registration Document Main Registration Folder Selection Screen

Next, the temporary registration document main registration folder selection screen 2701 will be described with reference to FIG. 27. FIG. 27 is an example of a temporary registration document folder selection screen displayed on the client PC 114. The display processing of this screen is executed with the display unit 115 based on a command from an unshown CPU. A keyboard or mouse is used for input operation by the user on the present screen.

A temporary registration document ID display 2702, temporary registration document name display 2703, folder list display 2704, folder 2705, selection folder 2706, OK button 2707, and cancel button 2708 are displayed on the temporary registration document main registration folder selection screen 2701. Also, for example a temporary registration user ID, temporary registration user name, temporary registration user email address, file size, property button, and help button can be added to the temporary registration document main registration folder selection screen 2701.

The temporary registration document ID display 2702 is a display of a temporary registration document ID of the temporary registration document selected by the user with the temporary registration document main registration screen 2601.

The temporary registration document name display 2703 is a display of a temporary registration document name of the temporary registration document selected by the user with the temporary registration document main registration screen 2601. The temporary registration document name display 2703 is provided on the temporary registration document main registration folder selection screen 2701 according to the present embodiment, but the temporary registration document name display 2703 is not necessary.

The folder list display 2704 is a list display of the folders to which the user can main-register a document. The folder 2705 is a display of a folder to which the user can main-register a document. The selection folder 2706 is a button to accept selection input from the user for the folder to which the temporary registration document is main-registered. In the case that the selection folder 2706 is pressed, the user can select the folder which the user desires to main-register the temporary registration document.

The OK button 2707 is a button for the client PC 114 to accept instructions from the user for transmitting information of the folder selected with the selection folder 2706 from the folder list display 2704 to the document managing server 101 and performing main registration of the temporary registration document. Upon the OK button 2707 being pressed, the overall processing unit 116 transmits the folder information selectively input with the selection folder 2706 of the folder list display 2704 to the document managing server 101. Upon the temporary registration document main registration processing ending with the document managing server 101, the overall processing unit 116 receives the main registration result of the temporary registration document from the document managing server 101. The overall processing unit 116 requests the display unit 115 to display the main registration result of the temporary registration document.

The cancel button 2708 is a button for the client PC 114 to cancel the folder selection by the user for the temporary registration document to be main-registered, and to transition to the temporary registration document main registration screen 2601. Upon the cancel button 2708 screen being pressed, the overall processing unit 116 requests the display unit 115 to display the temporary registration document main registration screen 2601.

### Temporary Registration User Login Screen

Next, a temporary registration user login screen 2801 will be described with reference to FIG. 28. FIG. 28 is an example of a temporary registration user login screen displayed on the client PC 114. The display processing of this screen is executed with the display unit 115 based on a command from an unshown CPU. A keyboard or mouse is used for input operation by the user on the present screen.

An email address input box 2802 and OK button 2803 are displayed on the temporary registration user login screen 2801. Also, for example a password input box, user group input box, and user affiliation input box can be added to the temporary registration user login screen 2801 as temporary registration user information.

The email address input box 2802 is an input box for the client PC 114 to accept input from the user for the temporary registration user email address in the temporary registration user information. The input email address is transmitted to the document managing server 101 by the overall processing unit 116, and is employed for temporary registration user authentication with the document managing server 101.

The OK button 2803 is a button for the client PC 114 to accept instructions from the temporary registration user for transmitting an email address to the document managing server 101 and performing user authentication. Upon the OK button 2803 being pressed, the overall processing unit 116 transmits the email address input in the email address input box 2802 to the document managing server 101. Upon the user authentication processing ending with the document managing server 101, the overall processing unit 116 receives the user authentication result thereof. In the case that the user authentication result received by the overall processing unit 116 is that authentication has failed, the overall processing unit 116 requests the display unit 115 to display a temporary registration user login error screen 2901 shown in FIG. 29 to be described later. In the case that the user authentication result received by the overall processing unit 116 is that the authentication has succeeded, the overall processing unit 116 requests the display unit 115 to display a temporary registration document obtaining screen 3001 shown in FIG. 30 to be described later.

### Temporary Registration User Login Error Screen

Next, the temporary registration user login error screen 2901 will be described with reference to FIG. 29. FIG. 29 is an example of a temporary registration user login error screen displayed on the client PC 114. The display processing of this screen is executed with the display unit 115 based on a command from an unshown CPU. A keyboard or mouse is used for input operation by the user on the present screen.

An email address input box 2902 and OK button 2903 are displayed on the temporary registration user login error screen 2901. Also, for example a password input box, user group input box, user affiliation input box can be added to the temporary registration user login error screen 2901 as temporary registration user information.

The email address input box 2902 is an input box for the client PC 114 to accept re-input from the user for an email address in the user information. The re-input email address is transmitted to the document managing server 101 by the overall processing unit 116, and is employed for user authentication with the document managing server 101.

The OK button 2903 is a button for the client PC 114 to accept instructions from the user for transmitting an email address to the document managing server 101 and performing user authentication again. Upon the OK button 2903 being pressed, the overall processing unit 116 transmits the email address input in the email address input box 2902 to the document managing server 101. Upon the user authentication processing ending with the document managing server 101, the overall processing unit 116 receives the user authentication result thereof. In the case that the user authentication result received by the overall processing unit 116 is that authentication has failed, the overall processing unit 116 requests the display unit 115 to display the temporary registration user login error screen 2901 again. In the case that the user authentication result received by the overall processing unit 116 is that the authentication has succeeded, the overall processing unit 116 requests the display unit 115 to display the temporary registration document obtaining screen 3001 shown in FIG. 30 to be described later.

### Temporary Registration Document Obtaining Screen

Next, the temporary registration document obtaining screen 3001 will be described with reference to FIG. 30. FIG. 30 is an example of the temporary registration document obtaining screen displayed on the client PC 114. The display processing of this screen is executed with the display unit 115 based on a command from an unshown CPU. A keyboard or mouse is used for input operation by the user on the present screen.

A temporary registration document list display 3002, temporary registration document selection radio button 3003, temporary registration document ID 3004, temporary registration document display 3005, valid period display 3006, obtain button 3007, and cancel button 3008 are displayed on the temporary registration document obtaining screen 3001. Also, for example a temporary registration user ID, temporary registration user name, temporary registration user email address, file size, property button, and help button can be added to the temporary registration document obtaining screen 3001.

The temporary registration document list display 3002 is a list display of temporary registration document which the temporary registration user can obtain.

The temporary registration document selection radio button 3003 is a button to accept selection input of the temporary registration document obtained from the temporary registration user. In the case that the temporary registration document selection radio button 3003 is pressed, the temporary registration document which the temporary registration user desires to obtain can be selected.

The temporary registration document ID display 3004 is a display of the temporary registration document ID of a temporarily registered document.

The temporary registration document name display 3005 is a display of the temporary registration document name of the temporarily registered document. The temporary registration document name display 3005 is provided on the temporary registration document obtaining screen 3001 according to the present embodiment, but the temporary registration document name display 3005 is not necessary.

The valid period display 3006 is a display of the valid period of a temporarily registered document. The valid period display 3006 is provided on the temporary registration document obtaining screen 3001 according to the present embodiment, but the valid period display 3006 is not necessary.

The obtain button 3007 is button for the client PC 114 to accept instructions from the temporary registration user to transmit the temporary registration document ID to the document managing server 101 and to obtain the temporary registration document. Upon the obtain button 3007 being pressed, the overall processing unit 116 transmits the temporary registration document ID of the temporary registration document information selectively input in the temporary registration document selection radio button 3003 to the document managing server 101. Subsequently, the overall processing unit 116 receives the selected temporary registration document from the document managing server 101. The processing is then ended.

The cancel button 3008 is a button for the client PC 114 to cancel the obtaining of the temporary registration document by the temporary registration user, and to transition to the temporary registration user login screen 2801. Upon the cancel button 3008 screen being pressed, the overall processing unit 116 requests the display unit 115 to display the temporary registration user login screen 2801.

### Second Embodiment

A second embodiment differs from the first embodiment in the following points. That is to say, with the second embodiment, in the case that registration of a temporary registration user is rejected by the manager in the temporary registration user main registration processing with the first embodiment, a temporary registration document is appended to the temporary registration user rejection notification email and transmitted. That is to say, in the case that rejection of main registration of the temporary registration user is requested by the manager with the document managing system according to the second embodiment, the temporary registration document associated with the temporary registration user is appended to the temporary registration user rejection notification email, and transmitted to the email address of the temporary registration user. Further, the temporary registration document and temporary registration user are deleted from the document managing server. Thus, since the document managing server does not need to maintain the document for a fixed period of time, the capacity of the HDD storing the temporary registration document, temporary registration document information, and temporary registration user information can be reduced more than with the first embodiment.

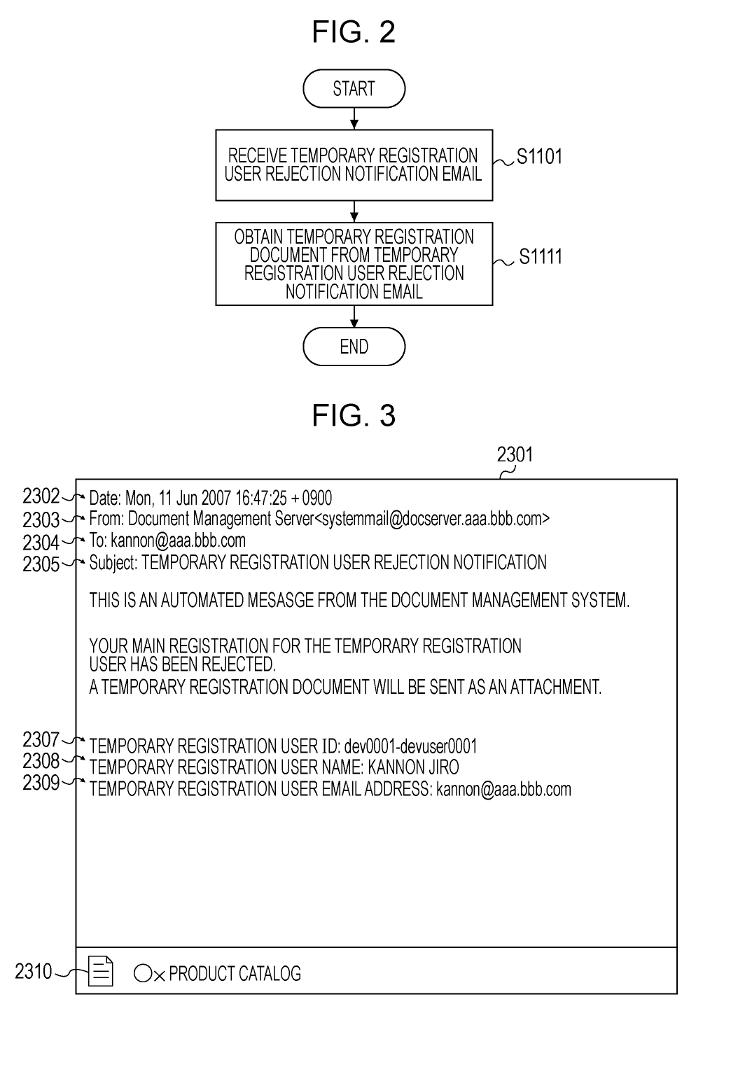

The second embodiment differs from the first embodiment in the following point. That is to say, with the second embodiment, the processing with the request processing unit 107 and overall processing unit 116 in FIG. 1 differs from the first embodiment. Also, with the second embodiment, the flowcharts in FIGS. 8 and 11 and the email in FIG. 23 differ from the first embodiment. Also, with the second embodiment, not employing the flowchart in FIG. 12 and the screens in FIGS. 28 through 30 differs from the first embodiment. Also, with the second embodiment, the addition of the flowcharts in FIGS. 2 and 31 and the email in FIG. 3 differs from the first embodiment. Other than the above-described points of difference, the second embodiment is completely the same as the first embodiment.

Note that FIG. 31 with the second embodiment is to replace FIG. 8 with the first embodiment. FIG. 2 with the second embodiment is to replace FIG. 11 with the first embodiment. FIG. 3 with the second embodiment is to replace FIG. 23 with the first embodiment.

### Workflow Test System

First, only the portions of the document managing system according to the present invention which differ from the first embodiment will be described with reference to FIG. 1. FIG. 1 is a block diagram showing the document managing system according to an embodiment of the present invention.

The request processing unit 107 has a function to transmit an email of the temporary registration user rejection notification email 2301 shown in FIG. 3 via the network 108.

The request processing unit 107 performs processing as described below as to a main registration request for a temporary registration user from the client PC 114. The request processing unit 107 receives a user ID and password along with an authentication request. The request processing unit 107 transmits the received user ID to the user information managing unit 102 and requests a readout of user information as to the user ID. The request processing unit 107 receives user information from the user information managing unit 102. The request processing unit 107 determines whether or not the password in the received user information matches the password received from the client PC 114. Further, the request processing unit 107 determines whether or not the manager flag of the received user information is “1”, i.e. is a manager. In the case that these conditions are met, the request processing unit 107 requests the temporary registration user information managing unit 104 to read out all of the temporary registration user information. The request processing unit 107 receives all of the temporary registration user information from the temporary registration user information managing unit 104. The request processing unit 107 transmits a message to the effect that authentication has succeeded and all of the temporary registration user information, having determined that the received user ID and password are correct to the client PC 114. Further, the request processing unit 107 receives the temporary registration user ID to main-register or reject, and a message to the effect of whether to main-register or reject is received from the client PC 114. In the case that the received message to the effect of whether or not to main-register or reject is a message to the effect of main-registering, the request processing unit 107 transmits the received temporary registration user ID to the temporary registration user information managing unit 104, and requests a readout of the temporary registration user information as to the temporary registration user ID. Upon receiving the temporary registration user information from the temporary registration user information managing unit 104, the request processing unit 107 transmits the received temporary registration user information to the user information managing unit 102, and requests main registration of the user information. Upon receiving a message to the effect that the main registration of the user information is ended from the user information managing unit 102, the request processing unit 107 transmits the temporary registration user main registration notification email shown in FIG. 22 addressed to the device user email address of the temporary registration user information. In the case that the message received from the client PC 114 to the effect of whether or not to main-register or reject is a message to the effect of rejecting, the request processing unit 107 transmits the received temporary registration user ID to the temporary registration user information managing unit 104, and requests a readout of the temporary registration user information as to the temporary registration user ID. Upon receiving the temporary registration user information from the temporary registration user information managing unit 104, the request processing unit 107 transmits the temporary registration user ID to the temporary registration document information managing unit 106, and requests a readout of the temporary registration document associated to the temporary registration user. Upon receiving the temporary registration document, the request processing unit 107 appends the received temporary registration document to the temporary registration user rejection notification email 2301 in FIG. 3, addressed to the device user email address of the temporary registration user information, and transmits.

Also, the overall processing unit 116 has a function to receive an email such as the temporary registration user rejection notification email 2301 shown in FIG. 3, via the network 108.

The overall processing unit 116 performs processing as described below for temporary registration document transmitting request processing. The overall processing unit 116 receives the temporary registration user rejection notification email 2301 shown in FIG. 3, via the network 108. The overall processing unit 116 obtains the temporary registration document of the received temporary registration user rejection notification email shown in FIG. 3.

### Flowchart of Document Managing Server at Time of Temporary Registration User Main Registration/Rejection

Next, only the portions differing from FIG. 8 of the temporary registration user main registration processing by the document managing server 101 will be described with reference to FIG. 31. FIG. 31 is a flowchart showing a sequence of temporary registration user main registration processing by the document managing server 101, and replaces the flowchart in FIG. 8. Each step in the flowchart in FIG. 31 is completely the same embodiment as FIG. 8 of the first embodiment, except for the point that step S807 differs and the point that steps S811 and S812 are added. This sequence is executed with an unshown CPU.

In step S807, the request processing unit 107 transmits the temporary registration user rejection notification email 2301 shown in FIG. 3, addressed to the email address of the temporary registration user of the temporary registration user ID received in step S805. First, the request processing unit 107 transmits the temporary registration user ID received in step S805 to the temporary registration user information managing unit 104, and requests a readout of the temporary registration user information as to the temporary registration user ID. The temporary registration user information managing unit 104 reads out the temporary registration user information as to the received temporary registration user ID, and transmits this to the request processing unit 107. The request processing unit 107 receives the temporary registration user information. Also, the request processing unit 107 transmits the temporary registration user ID received in step S805 to the temporary registration document information managing unit 106, and requests a readout of the temporary registration document associated with the temporary registration user ID. The temporary registration document information managing unit 106 reads out the temporary registration document information associated to the received temporary registration user ID. Further, the temporary registration document information managing unit 106 reads the temporary registration document in the temporary registration document saving folder of the read out temporary registration document information, and transmits the read out temporary registration document and the temporary registration document information to the request processing unit 107. The request processing unit 107 receives the temporary registration document from the temporary registration document information managing unit 106. The request processing unit 107 appends the temporary registration document received with the temporary registration user rejection notification email 2301 shown in FIG. 3 and transmits this addressed to the email address of the received temporary registration user information.

Upon the processing in step S807 ending, the temporary registration document obtaining processing by the client PC of the user shown in FIG. 2 is executed. The processing is then advanced to step S811.

In step S811, the request processing unit 107 transmits the temporary registration document of the temporary registration document information received in step S807 to the temporary registration document information managing unit 106, and requests deletion of the temporary registration document. The temporary registration document information managing unit 106 deletes the temporary registration document of the temporary registration document saving folder of the received temporary registration document information. Also, the temporary registration document information managing unit 106 deletes the received temporary registration document information, and transmits the temporary registration document and a message to the effect that the temporary registration document information has been deleted to the request processing unit 107. The request processing unit 107 receives the temporary registration document and the message to the effect that the temporary registration document information has been deleted. The processing is then advanced to step S812.

In step S812, the request processing unit 107 transmits the temporary registration user ID received in step S807 to the temporary registration user information managing unit 104, and requests deletion of the temporary registration user information of the temporary registration user ID. The temporary registration user information managing unit 104 deletes the temporary registration user information of the received temporary registration user ID, and transmits a message to the effect that the temporary registration user has been deleted to the request processing unit 107. The request processing unit 107 receives the message to the effect that the temporary registration user has been deleted. The processing is then advanced to step S810. The processing in the flowchart shown in FIG. 8 is then ended.

### Flowchart of Client PC at Time of Temporary Registration Document Obtaining

Next, only the portions differing from FIG. 11 of the temporary registration document obtaining processing by the client PC 114 will be described with reference to FIG. 2. FIG. 2 is a flowchart showing a sequence of temporary registration document obtaining processing by the client PC 114, and replaces the flowchart in FIG. 11. Each step in the flowchart in FIG. 2 is completely the same embodiment as FIG. 11 of the first embodiment, except for the point that step S1101 differs, steps S1102 through S1110 are deleted, and step S1111 is added. This sequence is executed with an unshown CPU.

In step S1101, the overall processing unit 116 receives the temporary registration user rejection notification email 2301 shown in FIG. 3, which is transmitted addressed to the email address of the temporary registration user from the document managing server 101. The processing is then advanced to step S1111.

In step S1111, the overall processing unit 116 obtains the temporary registration document 2310 which is appended to the temporary registration user rejection notification email 2301 shown in FIG. 3 which is received in step S1101. The processing in the flowchart shown in FIG. 11 is then ended.

### Diagram to Show Temporary Registration User Rejection Notification Email

Next, only the portions differing from FIG. 11 of the temporary registration document obtaining processing by the client PC 114 will be described with reference to FIG. 2. FIG. 2 is a flowchart showing a sequence of temporary registration document obtaining processing by the client PC 114, and replaces the flowchart in FIG. 11. Each step in the flowchart in FIG. 2 is completely the same embodiment as FIG. 11 of the first embodiment, except for the point that step S1101 differs, steps S1102 through S1110 are deleted, and step S1111 is added. This sequence is executed with an unshown CPU.

Next, only the portions differing from FIG. 23 of the temporary registration user rejection notification email 2301 will be described with reference to FIG. 3. As shown in FIG. 3, the temporary registration user rejection notification email 2301 is completely the same embodiment as FIG. 23 in the first embodiment, except for the point that the URL 2306 of the temporary registration user login screen is deleted and the temporary registration document 2310 is added. The temporary registration document 2310 is the appended temporary registration document which is temporarily registered in the document managing server 101.

Note that a document managing method according to the invention described above can be recorded on a computer readable storage medium as a computer program for a computer to execute, and employed.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2007-245369 filed Sep. 21, 2007, which is hereby incorporated by reference herein in its entirety.

What is claimed is:

1. A document management server comprising:
a storage unit configured to store a document as associated with a temporarily registered ID;
a determining unit configured to determine whether to perform main registration of said temporarily registered ID or to reject the main registration of said temporarily registered ID; and
a transmitting unit configured to transmit information for the purpose of obtaining said document to a transmission destination associated with said temporarily registered ID, in the case that said determining unit determines to reject the main registration of said temporarily registered ID.

2. The document management server according to claim 1, further comprising:
an associating unit configured to perform the main registration, and further associate, with the ID regarding which main registration has been performed, a document that is associated with said temporarily registered ID and stored, in the case that said determining unit determines to perform the main registration.

3. A document management server comprising:
a storage unit configured to associate a document with an ID and store the document;
a determining unit configured to determine whether to register said ID or reject the registration of said ID; and
a transmitting unit configured to transmit information for the purpose of obtaining said document to a transmission destination associated with said ID, in the case that said determining unit determines to reject the registration of said ID.

4. A document management server comprising:
a temporary registration unit for user information configured to associate a user ID of the document management server with a user ID of an image forming device and temporarily register the user ID of the document management server;
a temporary registration unit for document information configured to receive a document transmitted by said image forming device and temporarily register document information as a document associated with the temporary registration user ID, which is temporarily registered by the temporary registration unit for user information;
a main registration unit for user information configured to perform main registration of the temporary registration user ID that is temporarily registered by said temporary registration unit for user information, with the temporary registration user ID as the user ID, according to input from a manager received from a client PC of the manger; and
a main registration unit for document information configured to receive a folder arranged for main registration of a temporarily registered document with said temporary registration unit for document information from the client PC by input from the user, after the user ID is main-registered with said main registration unit for user information that is transmitted from the client PC of the user and login is performed, and said temporarily registered document information is main-registered in said folder.

5. A control method for a document management server comprising:
storing a document as associated with a temporarily registered ID;
determining whether to perform main registration of said temporarily registered ID or to reject the main registration of said temporarily registered ID; and
transmitting information for the purpose of obtaining said document to a transmission destination associated with said temporarily registered ID, in the case of having determined to reject the main registration of said temporarily registered ID.
